(19) United States
(12) Patent Application Publication
(10) Pub. No.: US 2017/0104799 A1
(43) Pub. Date: Apr. 13, 2017

(54) SYSTEM AND METHOD FOR COMMUNICATING INFORMATION ABOUT INTERESTING OCCURRENCES AT A DATA NODE TO A SUBSCRIBER APPLICATION

(71) Applicant: Cyanogen Inc., Palo Alto, CA (US)

(72) Inventors: Leslie Prock, Edgewood, WA (US); Steve Kondik, Kent, WA (US); Ravi Subramanian, Kirkland, WA (US)

(21) Appl. No.: 15/289,120

(22) Filed: Oct. 7, 2016

Related U.S. Application Data
(60) Provisional application No. 62/238,863, filed on Oct. 8, 2015.
(60) Provisional application No. 62/307,091, filed on Mar. 11, 2016.

(51) Int. Cl. H04L 29/06; H04W 12/06; H04L 12/26; H04L 12/24

(52) U.S. Cl. CPC H04L 65/4076; H04L 41/22; H04W 12/06; H04L 43/08; G06Q 10/1093

(57) ABSTRACT

A method and system for providing information to an application related to an occurrence at a data node. A data node may include an application running on a mobile device. The data node generates an event when it observes a predefined occurrence. The predefined occurrence may be functionality of an application, data being copied, a message being received, or the like. The event generated by the data node includes information taken from a semantic space defined by a domain but selected based at least in part on the occurrence. A request is received from an application for events meeting interest criteria specified by the application. The system determines whether to establish a subscription for the application. If it does, the system delivers events meeting interest criteria for the subscription to the subscriber application.

### CROSS-REFERENCE TO RELATED APPLICATIONS

The present application claims priority to and the benefit of U.S. Provisional Application No. 62/307,091, entitled “SYSTEM AND METHOD FOR COMMUNICATING INFORMATION ABOUT INTERESTING OCCURRENCES AT A DATA NODE TO A SUBSCRIBER APPLICATION,” filed Oct. 8, 2015, and U.S. Provisional Application No. 62/238,863, entitled “SYSTEM AND METHOD FOR COMMUNICATING INFORMATION ABOUT INTERESTING OCCURRENCES AT A DATA NODE TO A SUBSCRIBER APPLICATION,” filed Mar. 11, 2016. The disclosures of the above-listed applications are hereby incorporated by reference in their entireties.

### BACKGROUND

A user of a mobile device interacts with different applications on a regular basis. Most of these applications rely on proprietary data, and each receives different user input and hosts unique experiences and functionality for a user. Some applications share data with other applications. For example, an email application may give a calendar application email messages that include calendar invitations, enabling the calendar application to automatically add an event to a user's schedule when the user accepts an invitation by email. An application can offer a more robust user experience when it uses information shared by another application.

Most applications running on a device do not share well with others. If a first is not developed with a second's input, it is unlikely that the first will receive meaningful data from the second. One way for an application to communicate with other applications is to send broadcasts to the other applications. However, when many applications each send broadcasts, it can become difficult for an application receiving the broadcasts to separate the wheat from the chaff. Furthermore, applications that send broadcasts indiscriminately to other applications can risk a user's security and privacy. Moreover, this constant stream of chatter can reduce a device's performance and waste its battery power.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a diagram of a suitable environment in which an event distillation system for distilling and providing events from data nodes to a subscriber application may operate.

FIG. 2 is a diagram of a system for distilling and providing events from data nodes to a subscriber application.

FIG. 3 is a system diagram of an event distillation system for distilling and providing events from data nodes to a subscriber application.

FIG. 4 is flow diagram depicting steps performed by an event distillation system for subscribing an application for events provided by data nodes to the event distillation system and for providing an event, determined to be of interest to the application, to the application.

FIG. 5 is a table showing an exemplary event delivery list created and maintained by an event distillation system.

FIG. 6 is a table showing an exemplary subscription list for subscriptions held by subscriber applications for events meeting interest criteria of the subscriptions.

FIG. 7 is a diagram of a mobile device showing a representative graphical user interface generated by an event distillation system for receiving permission from a user to provide events to an application interested in being provided events.

FIG. 8 is a representative graphical user interface generated by the system for quickly receiving from a user a grant of permission or a revocation of permission related to a data node providing events to an event distillation system or a subscriber application receiving events from the event distillation system.

### DETAILED DESCRIPTION

A method and system are described for distilling an event from among events received from data nodes, determining that the event is of interest to a subscriber application, and delivering the event to a subscriber application. An event is a unit of information that is shared by a data node and consumed by a subscriber application. Content of an event provides information related to an occurrence at a data node. The system enables the sharing of information about occurrences at a data node among applications.

An event comprises information that is related to an occurrence and shared by a data node via the system. A data node may comprise a publisher application. An event shared by a data node may be delivered by the system to one or more subscriber applications. An event belongs to a domain. A domain is a semantic space of information that contextualizes events emitted by data nodes. For example, an email domain may encompass meaningful events triggered by applications that deal with or relate to a user's email. Domains can be useful for helping to disambiguate events that may have information with ambiguous names. For example, an action of play included in an event may be associated with one thing in a games domain but another thing in the music domain.

A filter is provided by a subscriber application and includes interest criteria, which indicate the subscriber's interest in information about occurrences at data nodes. The system determines whether or not to subscribe the subscriber application for events meeting the filter. Filters are specified by subscriber applications using a subscription API. The system compares these filters to received events to identify events that are of interest to a subscriber application. The system receives user input providing or revoking permission for a subscription or for delivery of an event or data that is supplemental to the event, and adjusts permissions accordingly. A user's permission, or lack thereof, may affect which data nodes and subscriber applications are allowed to publish or subscribe for events, respectively, and which events are provided to a subscriber application.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

The following discussion includes examples of a system for distilling events provided by data nodes for determining whether an event is of interest to a subscriber application and delivering the event to the subscriber application if it is. The system is described with respect to a number of processes that it may implement and numerous examples of how it may be implemented.

### Suitable Environments

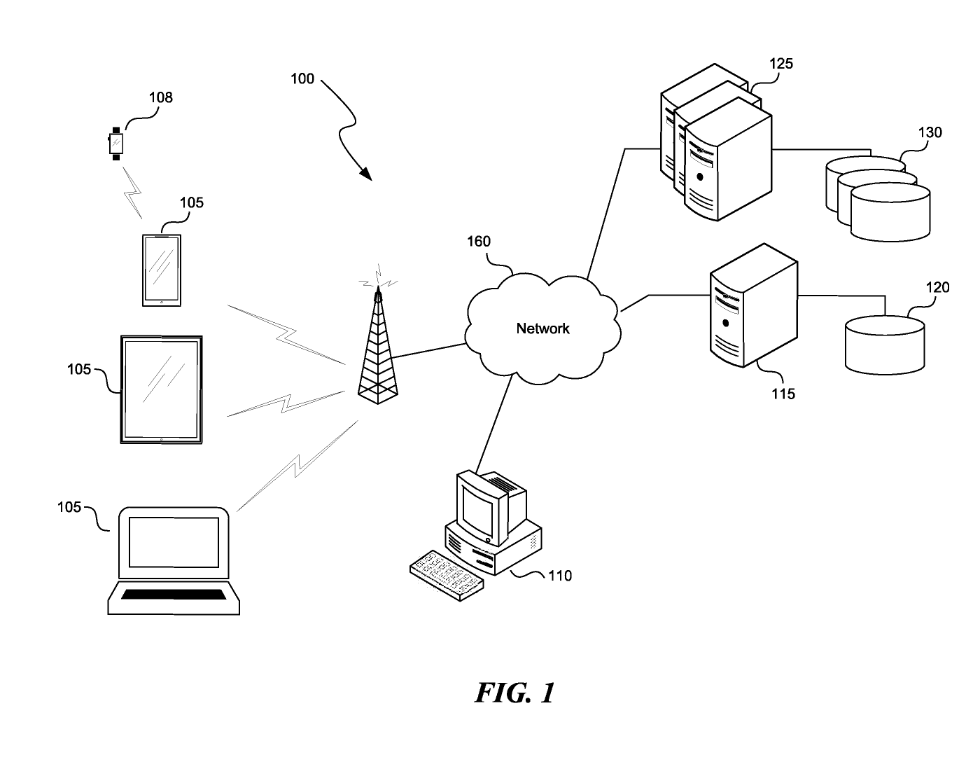

FIG. 1 and the following discussion provide a brief, general description of a suitable computing environment 100 in which a system for identifying events of interest to a subscriber application from among events generated by data nodes and providing those events to the subscriber application, may be implemented. Although not required, aspects and implementations of the invention will be described in the general context of computer-executable instructions, such as routines executed by a general-purpose computer, a server computer, or other computing systems and devices. The invention can also be embodied in a special purpose computer or data processor that is specifically programmed, configured, or constructed to perform one or more of the computer-executable instructions explained in detail herein. Indeed, the terms “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programmable logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory device for storing data. Computer-executable instructions may include one or more program modules, which include routines, programs, objects, components, data structures, and so on that perform particular tasks or implement particular abstract data types.

The system and method can also be practiced in distributed computing environments, where tasks or modules are performed by remote processing devices, which are linked through a communications network 160, such as a Local Area Network (“LAN”), Wide Area Network (“WAN”), or the Internet. In a distributed computing environment, program modules or subroutines may be located in both local and remote memory storage devices. Aspects of the invention described herein may be stored or distributed on tangible, non-transitory computer-readable media, including magnetic and optically readable and removable computer discs, and stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, an event distillation system for providing a subscriber application with events that are of interest to the subscriber application, according to embodiments of the invention, operates in a mobile device 105, a personal computer 110, a wearable device 108, or among at least one of these devices and another device. For example, the system can be distributed among one of these devices, such as one of mobile devices 105, and server computers 115. The system may also be implemented in another computing device, including a set top box, a smart appliance, an autonomous vehicle navigation system, a digital camera, or the like. The mobile devices 105 and personal computers 110 communicate through one or more wired or wireless networks 160 with each other and with the servers 115. The wearable device 108 can communicate with another device, such as the mobile devices 105, via a short-range communication protocol, such as Bluetooth®. The system can communicate with one or more third party servers 125. Data used and provided by third party servers can be contained in data storage areas 130. For example, events at a data node may be received from a third party server or generated based on an action occurring at the third party server. Data storage area 120 contains data utilized by the system, and, in some implementations, software necessary to perform functions of the system. For example, the data storage area 120 may contain permissions data related to events that the system may provide for a subscriber application.

The mobile devices 105 and computer 110 communicate with each other and server 115 and third party servers 125 through networks 160, including, for example, the Internet. The mobile devices 105 communicate wirelessly with a base station or access point using a wireless mobile telephone standard, such as the Global System for Mobile Communications (GSM), or another wireless standard, such as IEEE 802.11, and the base station or access point communicates with the server 115 via the networks 160. Computers 110 communicate through the networks 160 using, for example, TCP/IP protocols.

### Suitable Systems

The event distillation system distills events from among events received from data nodes, identifying events that are of interest to a subscriber application. An event is a unit of information that is shared by a data node with the event distillation system, and provided by the event distillation system to a subscriber application, to be consumed by the subscriber application. Included in event data for an event is information related to an occurrence at a data node. The system balances the sometimes competing interests of a user, subscriber applications, and data nodes, delivering events of interest to the subscriber application, enabling it to provide a more compelling and informative experience for the user.

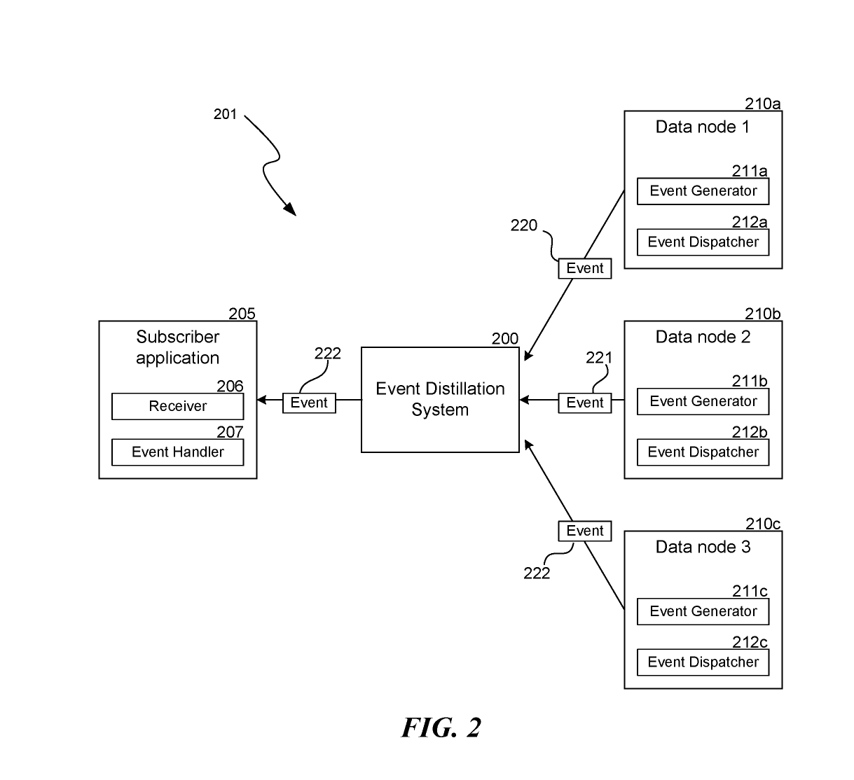

FIG. 2 shows a diagram 201 of basic event transmission between data nodes 210a-c and a subscriber application 205, via an event distillation system 200. The event distillation system 200 can run, for example, on mobile device 105. Data nodes 210a-c may include applications or services running on the mobile device 105. A data node may comprise an application process for a mobile device application. As examples, data node 210a may include an email application, data node 210b may include a messaging application, and data node 210c may include a music player application. The subscriber application 205 can also run on the mobile device 105. A subscriber application may comprise an application process for a mobile device application. For example, subscriber application 205 can include an intelligent personal assistant running on a mobile device that the system is operating on. An application can simultaneously act as a data node, generating events consumed by subscriber applications, and as a subscriber application, consuming events generated by other data nodes. Event generators 211a-c and event dispatchers 212a-c store data in and read data from data node storage areas (not pictured) and communicate with remote services and devices. The event distillation system, according to some implementations, may include one or more data nodes or components of the data nodes and one or more subscriber applications or components of the subscriber applications. For example, the event distillation system may include an event generator and an event dispatcher of a data node and a receiver and event handler of a subscriber application.

An event generator, such as the event generator 211a, is configured to monitor for predefined occurrences at a data node and create an event when it observes a predefined occurrence. An event dispatcher, such as the event dispatcher 212a, of the data node is configured to provide events generated by the event generator to the event distillation system 200. The event generator creates an event using a domain definition. A domain is a self-contained contextual space of information with its own understood semantics. The event distillation system promulgates a domain definition to data nodes and subscriber applications, and a data node uses it for creating events that belong to the domain described in the domain definition. A subscriber application processes a received event using the domain definition and uses the event's contents as it sees fit.

An event generator monitors a data node for a predefined occurrence. An occurrence can comprise data being modified, copied, accessed, or the like, at a data node. In some implementations, an occurrence comprises functionality of an application. For example, for a data node that comprises a music player application, an event generator may monitor for predefined occurrences of functionality including playing a track, stopping a track, skipping a track, and so forth. An occurrence may also include a status update. For example, an event generator may periodically check a status of data at a data node. An event generator may have a list of predefined occurrences to monitor for and information for monitoring for the occurrences. An administrator of the data node can provide a list of predefined occurrences. In some implementations, a domain definition includes a predefined occurrence to monitor for and instructions for monitoring for the occurrence.

An event generator monitors for an occurrence in various ways. In some implementations, an event generator monitors for a predefined occurrence by monitoring for a predetermined subroutine associated with functionality at a data node. For example, an event generator can monitor processes of an application for a predetermined subroutine associated with an occurrence. In some implementations, an event generator monitors for an occurrence by monitoring for a callback associated with the occurrence. For example, an administrator of a data node comprising an application can add a callback at the data node causing it to execute the callback at an occurrence of predetermined functionality, which an event generator interprets as an occurrence at the data node. In some implementations, an event generator monitors for an occurrence with respect to data at a data node by periodically polling the data. For example, an event generator can poll a list of contacts stored at a data node for a social networking application to determine whether the list has changed, and it may determine that a predefined occurrence, associated with adding a contact, has happened when a new contact is determined to be in the list.

An event generator is configured to create an event in response to observing a predefined occurrence at a data node. In some implementations, an event generator only generates events of a single domain. For example, an event generator for a music application may only generate events that belong to a music domain. In some implementations, an event generator generates events that respectively belong to different domains. In some implementations, a predefined occurrence at a data node is associated with a domain definition, and upon observing the predefined occurrence, an event generator generates an event using the domain definition associated with the occurrence. For example, an event generator may refer to a list of predefined occurrences including an association between a predefined occurrence and a domain for an event that is to be created based on observing the predefined occurrence.

An event comprises properties and values for the properties. An event generator can select properties for an event, generated in response to an occurrence at a data node, and identify values for those properties using a domain definition. Example properties for an event include one or more of an action property, a target property, a publisher property, a context property, a series or group property, and an attributes property. An event can include various properties and sub-properties and values for the properties and sub-properties. As an example, an event may include an action property and an associated value, a target property and an associated value, and a context property, including context sub-properties of time and location and associated values. An event includes a domain property and a value comprising an identifier of the domain that it belongs to. An event generator can be configured to create events that are in an event format, which the event distillation system 200 and the subscriber application 205 are configured to parse. In some implementations, the event generator is configured to create events that are in JavaScript Object Notation (JSON) format. The following is example event data for an event, in JSON format:

```
{
  ″event″: {
    ″domain″: ″music″,
    ″version″: ″0.1.0-alpha″,
    ″id″: ″some-uuid″,
    ″publisher″: ″com.examplemusicapp.android″,
    ″target″: ″TRACK″,
    ″action″: ″PLAY″,
    ″timestamp″: ″unix timestamp″,
    ″location″: {
      ″lat″: 47.6097 N,
      ″long″: 122.3331 W
    },
    ″attributes″ : {
      ″id″: ″urn:some-examplemusicapp-track-id″,
      ″song title″: ″I just Can't Wait to be King″,
      ″artist″: ″Jason Weaver, Rowan Atkinson, Laura Williams″,
      ″album″: ″The Lion King (soundtrack)″,
      ″length″: 170
    },
    ″marker″: ″start″
  }
}
```

A domain definition includes parameters for creating and parsing events of a domain. An event generator creates events that have properties described by a domain definition. Values for these properties are determined using the domain definition. A domain definition can include predefined possible values for a property of an event, which an event generator at a data node can choose from in creating an event. A domain definition can include instructions for identifying a value for a property of an event. Domain definitions are stored in domain data storage 355 and in storage areas associated with data nodes and subscriber applications. As mentioned above, domain definitions can be created by an administrator of the system 200. In some implementations, a domain definition is created by and received from an application interested in subscribing for events. In some implementations, a domain definition is created by and received from a data node that generates and provides events that belong to the domain. The system 200 can distribute a domain definition among data nodes and applications interested in subscribing for events, enabling data nodes to create events that subscriber applications can accurately parse.

An event generator creates an event in response to observing a predefined occurrence at a data node. The event generator identifies a domain definition associated with the occurrence and adds domain information to the event, which may include a domain name, a domain identifier, and a version number for the domain definition. A domain name can describe a space for events that belong to the domain. Examples include, “email,” “music,” “location,” “navigation,” and “advertising.” A domain identifier is a unique identifier for the domain definition, such as “df-core.email.” A version identifies a version of a domain definition, enabling an evolution of the domain and backward compatibility as needed.

The event generator is configured to identify values for properties of the event using the identified domain definition. A domain definition can include predefined possible values for a property. In some implementations, a predefined occurrence that an event generator monitors for is associated with a predefined value for a property, as specified in a domain definition, and when an event generator observes the predefined occurrence, it creates an event and adds the predefined value associated with the observed occurrence to the event in association with the property. For example, an event generator may receive a list from an administrator of a data node that includes predefined occurrences that the event generator is to monitor for, and, for each predefined occurrence, the list includes an associated predefined action included in a domain definition.

A value for an action property can be a verb or another word describing an action taken in an occurrence. Example values for an action property in an email domain include “compose,” “send,” “receive,” and “delete.” In some implementations, an event generator adds a value not taken from a domain definition to an action property of an event. For example, an event generator may monitor data for activity surrounding the data and generate an event when activity being monitored for is observed. An action for the event may include the activity that was observed. For example, if an occurrence at a data node includes an activity of data being copied, deleted, modified, accessed, or the like, or a request has been received to access the data, a request has been received to copy the data, or so on, an event generator can include the activity that was determined to have occurred with respect to the data.

A target value for an event can be identified in a similar way as done to identify an action value. A target includes a subject involved with an occurrence. A target can refer to specific data, a category of data, an object, a graphical user interface element, or the like. A domain definition can include predefined possible values for a target property for an event. In some implementations, a domain definition includes an association between a predefined possible value for an action property and a predefined possible value for a target property, and an event generator creates an event and adds a predefined possible value for a target associated with a predefined possible value for an action that has been added to the event.

Multiple predefined possible values for a target property may be associated with a predefined possible value for an action property. An event generator is configured to determine which of the predefined possible target values to add to an event. An event generator may determine to add a predefined possible target value to an event based on an association between the predefined possible target value and an occurrence for which the event is being generated. For example, an event generator may receive a list from an administrator of a data node that includes predefined occurrences that the event generator is to monitor for, and, for each predefined occurrence, the list includes an associated predefined possible target value, which is taken from a domain definition and determined to be associated with the predefined occurrence by the administrator of the data node. In some implementations, an event generator identifies a target value for an event based at least in part on a subject involved in an occurrence. For example, an event generator may receive a list from an administrator of a data node that includes predefined occurrences that the event generator is to monitor for, and, for each predefined occurrence, the list includes predefined possible subjects for the occurrence and each predefined possible subject is associated with a predefined possible target from a domain definition. The event generator may observe an occurrence, determine which of predefined possible subjects the occurrence applies to, and add to an event a predefined target associated with the predefined possible subject that the occurrence applies to. Example target values for events created based on occurrences at a media player application include “track,” “album,” “video,” “MP3 file,” and “AVI file.”

An attributes property of an event includes additional details about a target, an action, a publisher of an event, or the like. For example, in an email domain, attributes may include values for a subject of an email, a sender of an email, a time that an email was sent, and so on. A domain definition can include predefined possible attributes for an event, and an event generator can identify values for those attributes. A domain definition may include a list of predefined possible target and action pairs, and for each distinct (target, action) pair, the domain definition includes an associated set of attribute keys. Attribute keys are attribute components that an event generator adds to an event. For example, in an email domain, attribute keys associated with a (target, action) pair of (“email,” “received”) may include <from>, <time>, and <subject> attribute keys. An event generator is configured to identify, based on a domain definition, a set of attribute keys associated with a (target, action) pair for an event it creates, and identify values for the attribute keys and add those values to the event. In some implementations, an event generator parses a subject of an occurrence to identify a value for an attribute key. For example, for an event that includes a (target, action) pair of (“email,” “received”), which is associated in a domain definition with attribute keys of <from> and <subject>, an event generator can parse an email that is the subject of the action, “received,” in order to identify values for <from> and <subject> attribute keys of the event. As an example, values for <from> and <subject> attribute keys that are associated with an (“email,” “received”) pair may include, for example, “noreply@fedex.com” and “Your package is on its way”, respectively. In some implementations, an event generator identifies values for attribute keys for an event based at least in part on metadata associated with a subject of an observed occurrence for the event. For example, for an event associated with an occurrence of a music file being played, metadata may identify an artist for the music file, an album, a year it was produced, and so forth, and the event generator can add this metadata to the event as values for attribute keys of the event.

An attribute key for an event may include instructions for obtaining data that is supplemental to the event. For example, if an event generator cannot or will not include all information about an occurrence that a subscriber application may wish for, the event generator can provide information for obtaining the information. For example, an attribute key for an event in an email domain associated with (target, action) pair, (“email,” “received”), may include <attachment>, and an event generator may add the <attachment>key and instructions for obtaining an attachment to an event when an email that is the subject of the event includes an attachment. In some implementations, an event generator adds attribute keys to an event for <content-id> and <access-method> for providing instructions to obtain supplemental data.

In some implementations, a value for an attribute key for obtaining supplemental data includes a uniform resource identifier (URI) enabling a subscriber application to query a content provider to obtain supplemental data. In some implementations, a value for an attribute key for obtaining supplemental data includes a uniform resource locator enabling a subscriber application to access the supplemental data over a network. In some implementations, instructions for obtaining supplemental data include instructions for the event distillation system to follow to obtain and cache supplemental data for distributing to a subscriber application that requests the data. In some implementations, a value for an attribute key for obtaining supplemental data includes a value indicative of a subscriber application needing to bind to a specific service and provide an event identifier to obtain the supplemental data.

The event generator can add other properties to an event. In some implementations, an event generator adds a delivery act for the event. A delivery act includes an act that is to be taken by the event distillation system 200 if an event including the delivery act is delivered to a subscriber application. In some implementations, an administrator of a data node provides instructions to an event generator that includes whether to add a delivery act to an event. In some implementations, an event generator adds a delivery act to an event if the event meets a delivery act criteria. Delivery act criteria can include that a delivery act is to be added to an event if the event includes a predefined target value or a predefined action, or the like. A delivery act can include transferring monetary value from an account associated with a subscriber to an account associated with a data node, and/or an account associated with a user, and/or an account associated with the system.

In some implementations, an event generator adds context information to an event. A domain definition may call for context information. In some implementations, an event generator automatically adds default context information to an event. In some implementations, an event generator adds context information based on context criteria being met. A context property of an event can include data associated with environmental conditions for a device or a user and/or information associated with circumstances under which the event was generated. Context information may include a timestamp for when an occurrence was observed at a data node. Context information may include a location where an occurrence was observed. Location can include a latitude and longitude of a mobile device, as measured by the mobile device when an action occurred. Context information can also include a network connected to by a device when an occurrence was observed, a signal detected by a receiver of the device when an occurrence was observed (e.g., service set identifiers (SSIDs) for a WiFi network sensed by the device), data from an accelerometer or another sensor of the device, devices sensed in a vicinity of the device, and so forth. In some implementations, an event generator adds context information to an event if context criteria are met. For example, context information can include a relative urgency of an event, and an event generator can add context information indicative of an emergency when it determines that context criteria for an emergency are met. In some implementations, a predefined occurrence is associated with context criteria for an emergency being met, and an event generator adds context information indicative of an emergency to an event associated with the occurrence. Context criteria may include that an occurrence for which an event is created be a predefined occurrence that is associated with an emergency. In some implementations, the event distillation system 200 adds context information to an event. For example, the event distillation system can add a location of a mobile device to an event when the event is given to the system by a data node if no location context information is included in the event.

An event can be discrete or a part of a group or series of events. When an event is one of a series or group of events, an event generator may add series or group information under a property of the event for this information. Series or group information includes an identifier for the series or group, and, if the event is part of a series, a marker indicative of a place in the series that the event belongs. In some implementations, an identifier for a series or group is a name of the series or group, or a UUID for the series or group. A series marker for an event may identify a total number of events that are part of a series and a place that the event is in the series. For example, a series marker may indicate that an event is a second event in a series of 20 events. In some implementations, a series marker for an event identifies a place that the event is in the series but does not identify a length of the series. For example, a series marker may identify that an event is a start of a series, an end of the series, or an intermediate event of the series. Series markers can be used by a subscriber application to track progress of activity at a data node. For example, an event generator for a music player application may create a series of events for actions at a data node related to playing an album. The event generator may generate a first event of a series when a “play” action is identified and subsequent events of the series as the music player plays through the tracks on the album.

An event generator can determine that an event is a part of a series or group, and label it as such, in various ways. In some implementations, an event generator determines that an event is part of a series or a group based at least in part on an action or a target for the event. For example, an event generator may receive from an administrator of a data node a list of actions and/or targets associated with an activity that involves multiple events, and the event generator can compare an identified action and/or target for a new event to those of the list in order to determine whether the new event is part of a series or group. In some implementations, an event generator determines that an event is part of a series or a group based at least in part on a previous event. For example, an event generator can be configured to generate events including a status update for an earlier event that is part of an activity. For an autonomous vehicle navigation system, for instance, an action of “begin navigation” may be associated with an event that commences a series of events. The event generator can generate subsequent events that include updated navigation data as attributes for the events. The event generator can add series markers for these subsequent events, indicating that the subsequent events are intermediate events. Finally, the event generator generates a final event of the series, including a series marker indicative of this status, when it identifies an action associated with finalizing the series. For an autonomous vehicle navigation system, this action may be that the vehicle has arrived at its destination location.

Other information that an event generator can add to an event includes an identifier for the event and a publisher of the event. An identifier for an event identifies the event uniquely in space and time. An identifier for an event can be a universally unique identifier (UUID). In some implementations, an event generator generates an identifier for an event. In other implementations, the event distillation system 200 generates and adds an identifier to a received event. An event generator can add a publisher of an event to the event. A publisher may include a package name of an application associated with a data node. Examples include “com.exampleemailapp.email” and “com.examplemusicapp.android. In some implementations, an event generator for a data node adds a publisher associated with the data node. In some implementations, an event generator adds priority information to an event. Priority information can be used by the system for determining whether to prioritize delivery of some events over delivery of others, and an event generator can prioritize delivery of its own events. For example, a predefined occurrence may be associated with a higher priority than another predefined occurrence is, and if an event generator determines that both the former and latter occurrences have happened, the event generator may add a higher priority to an event associated with the former occurrence than for to an event for the latter occurrence. In some implementations, an event generator adds a delivery requirement property to an event, which includes a restriction related to providing the event to a subscriber application. For example, an event generator may add a restriction to an event that it only be provided to a subscriber application meeting predefined criteria.

The event distillation system 200 receives events from data nodes via event dispatchers 212a-c at the data nodes 210a-c. An event dispatcher is configured to provide events generated by an event generator to the system 200. The event dispatcher may broadcast events to the system. For example, in an Android™ computing environment, the system may be provided events from a data node via a broadcast receiver. In some implementations, an event dispatcher throttles delivery of events to the event distillation system. For example, an event dispatcher may queue events for delivery to the event distillation system 200, providing an event when an event dispatching condition is met. An event dispatching condition may include that a predetermined number of events have accumulated at the event dispatcher. In some implementations, an event dispatching condition includes that an event has been queued to be delivered for a predetermined duration of time. In some implementations, an event dispatching condition includes that an event dispatcher has not delivered more than a predetermined quantity of events over a predefined time period. In some implementations, an event dispatching condition includes that a data node receive monetary value from the event distillation system and/or a subscriber application for a previous event that was delivered. In some implementations, an event dispatching condition includes that the event distillation system and/or a subscriber application complete its end of a bargain associated with a contract with a data node.

In the diagram 201, event dispatchers 212a-c output events 220, 221, and 222, generated by event generators 211a-c, respectively, at the data nodes 210a-c. The events are received by the event distillation system 200. The event distillation system distills the received events, identifying event 222 as being of interest to the subscriber application 205, and it delivers the event 222 to the subscriber application 205.

The subscriber application 205 includes a receiver 206 and an event handler 207. The receiver 206 receives events provided by the system 200. In some implementations, the receiver includes a broadcast receiver. In some implementations, when an event is available for delivery to a subscriber application, the system 200 delivers the event via a hidden broadcast receiver within an API employed by the subscriber application. In some implementations, the system transmits an event in a message that the broadcast receiver is configured to deconstruct to identify an event. The event handler 207 is configured to parse a received event based at least in part on a domain definition associated with the received event. In some implementations, an administrator of a subscriber application provides a list to the subscriber application that includes predefined possible values for a property included in a domain definition and/or combinations of predefined possible values for properties include in an event and functionality and/or data at the subscriber application. For example, an event handler for a subscriber application may include a list correlating predefined possible values for an action or a target of an event, as included in a domain definition, with data, actions, or functionality native to the subscriber application.

An event handler of a subscriber application is configured to obtain supplemental data for an event. For example, an event may include “content-id” and “access-method” fields among attributes of the event. When obtaining supplemental data for an event, the event handler can reference the data using a value for content-id included in the event. Supplemental data can be obtained directly from a data node, from a data repository over a network, from a service that the subscriber application must bind to, from the event distillation system, or the like, as specified in an event. For example, a value for an access-method field of an event may include “content-provider,” indicating a standard content provider, and a uniform resource identifier (URI) for the content provider. The event handler 207 may query the content provider to obtain supplemental data. As another example, a value for an access-method field may include a uniform resource locator (URL), which the event handler can use for accessing the supplemental data over a network. A value for an access-method field can identify a service, and the event handler causes the subscriber application to bind to the identified service, providing a content-id vale for the supplemental data in order to obtain the supplemental data from the service.

In some implementations, an event includes a price for supplemental data, and a subscriber application agrees to pay the price for the supplemental data when it requests and receives the supplemental data from the event distillation system 200. For example, an attribute property of an event may include “content-id” and “access-method” fields and a “price” field, including a value of “$0.01,” which is payable to a data node that provided the event if supplemental data associated with the event is delivered to a subscriber application that has requested the supplemental data in response to receiving the event. The event distillation system is configured to debit an account associated with a subscriber application and credit an account associated with a data node by a value specified in an event when the event distillation system delivers the event to the subscriber application. A subscriber application can bind to the system to receive supplemental data.

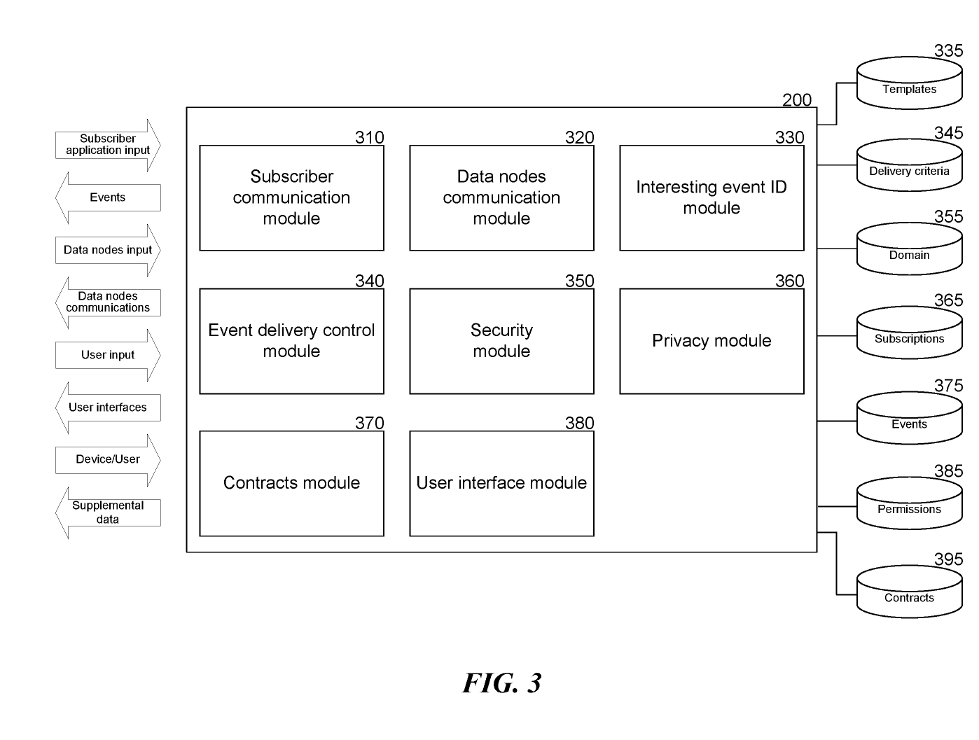

FIG. 3 is a block diagram of the event distillation system 200, which distils events received from data nodes, identifying events that are of interest to a subscriber application that it delivers to the subscriber application. A data node can be an application, a bound service, a third party content provider, a data repository, or the like. The event distillation system 200 can share information associated with an occurrence at a data node with a subscriber application without requiring a strict binding by the subscriber to the event distillation system 200 when no data is flowing, thereby minimizing power consumption and network usage for providing events to subscriber applications.

The system 200 includes a subscriber communication module 310, a data nodes communication module 320, an interesting event identification (ID) module 330, an event delivery control module 340, a security module 350, a privacy module 360, a contracts module 370, and a user interface module 380. The system 200 stores data in and retrieves data from templates data storage 335, delivery criteria data storage 345, domain data storage 355, subscriptions data storage 365, events data storage 375, permissions data storage 285, and contracts data storage 395. The system receives subscriber/potential subscriber application input, data nodes input, user input, and device/user data, and outputs events, user interfaces, data nodes communications, and supplemental data. In some implementations, the system receives and transmits data to third party services.

The system communicates with subscriber applications (including applications requesting a subscription) via the subscriber communication module 310. The system communicates with data nodes via the data nodes communication module 320. The subscriber communication module 310 and the data nodes communication module 320 may provide application programming interfaces (APIs) for communicating with subscriber applications and data nodes, respectfully. The subscriber communication module can be bound to by a subscriber application for communicating with the subscriber application. The event distillation system is configured to communicate with subscriber applications and data nodes that are local to a device that the event distillation system is operating on, and with subscriber applications and/or data nodes that run processes that are remote from a device that the event distillation system 200 operates on, or that run process that are distributed between a device local to the event distillation system and remote to the system 200.

The subscriber communication module 310 is configured to receive requests from applications to subscribe for events. A request from an application to subscribe for events includes a filter or an identifier for an existing filter that the subscriber application would like to subscribe to. A filter includes interest criteria, which the system uses for determining whether an event received from a data node is of interest to a subscriber application. The subscriber communication module passes a request from a subscriber application to subscribe for events to the event delivery control module 330 for determining whether to subscribe the application for events meeting a received filter. The subscriber communication module 310 is configured to communicate with a subscriber application regarding a subscription requested by the subscriber application, including whether the application has been subscribed for requested events or not. The subscriber communication module is configured to generate an identifier for a subscriber application that the system can use for referring to the subscriber application. For example, the subscriber communication module can generate a UUID to associate with a subscriber. An identifier for a subscriber can be stored in subscriptions data storage 365. The subscriber communication module can store a filter received from a subscriber application in association with information for communicating with the subscriber application, including an identifier for the subscriber.

The subscriber communication module 310 is configured to deliver events to a subscriber application. Events that are to be delivered are provided by the event delivery control module 340. When an event is received from a data node, the data nodes communication module stores the event in events data storage 375. An instruction received from the event delivery control module to deliver an event a subscriber application may include an identifier for an event stored in events data storage and an identifier for the subscriber application. The subscriber communication module is configured to pull the event from events data storage 375 and provide the event to the identified subscriber application. In some implementations, the subscriber communication module is bound to by a subscriber application in order for the subscriber communication module to provide an event to the subscriber application.

The subscriber communication module 310 is also configured to deliver supplemental data associated with an event to a subscriber application when the supplemental data is requested by the subscriber application. An event may include an attribute including instructions for obtaining supplemental data related to the event. For example, an event in an “email” domain may include instructions for obtaining a body of an email or an attachment to the email. In some implementations, the system caches supplemental data for an event in events data storage 375, and the subscriber communication module delivers the supplemental data when requested by a subscriber application. The subscriber communication module can be bound to by a subscriber application in order for the subscriber communication module to provide supplemental data to the subscriber application.

The data nodes communication module 320 communicates with data nodes providing events to the system. The data nodes communication module can provide an API for communicating with data nodes. The data nodes communication module can receive a request, via the API, from a data node to provide events to the system. In some implementations, the data nodes communication module receives information from an administrator of the system identifying data nodes that are permitted to provide events to the system. In some implementations, the data nodes communication module rejects events from a data node until approval to receive events from the data node is received from a user. For example, the data nodes communication module may receive a request from a data node to provide events to the system, and the data nodes communication module can instruct the user interface module 380 to generate a user interface for requesting and receiving permission from a user for a data node to provide events to the system.

The data nodes communication module 320 is configured to receive events from data nodes. In some implementations, the system binds to a data node to receive events from the data node. The data nodes communication module stores a received event in events data storage 375. In some implementations, the data nodes communication module is configured to monitor a data node in order to identify occurrences at the data node. For example, the data nodes communication module may include an event generator that monitors for predefined occurrences at a data node and generates an event when a predefined occurrence is determined to have happened. The system can promulgate a domain definition to subscriber applications and data nodes via the subscriber communication module 310 and the data nodes communication module 320 respective. For example, the subscriber communication module may receive a request from a subscriber application for a domain definition for an email domain, and the subscriber communication module can identify a domain definition for the email domain in domain data storage 355, which it provides to the subscriber application.

The interesting event ID module 330 receives from the subscriber communication module 310 a request from an application to subscribe for events meeting interest criteria. The interesting event ID module determines whether or not to subscribe an application for events meeting requested interest criteria and returns a message for the application, delivered via the subscriber communication module 310, which includes interest criteria that the application has been subscribed for, if any. When the interesting event ID module determines to subscribe an application for events, it adds an identifier for the application to a subscription list that it maintains, which associates applications and respective interest criteria that they are subscribed for. The interest criteria may comprise a filter identifier for a filter stored in subscriptions data storage. The interesting event ID module 330 examines events received from data nodes via the data nodes communication module 320, identifying events of interest for delivery to a subscriber application based on interest criteria for events that the application is subscribed for. The interesting event ID module provides an event determined to be of interest to a subscriber application to the event delivery control module, which determines whether to deliver the event to the subscriber application.

The interesting event ID module 330 determines whether to subscribe an application for events that meet interest criteria requested by the application. Interest criteria are included in a filter, and they include criteria for determining whether an event is of interest to a subscriber application. Interest criteria can include criteria directed to the various properties of an event and/or conditions for delivery of an event. For example, interest criteria for a domain of an event may include a domain name. Interest criteria for a domain of an event can also include a version number. For instance, domain criteria included in a filter may include that a domain for events provided to it belong to a domain that is named “df-core.email,” and is “version 1.0.” Interest criteria for an action property of an event may include a predefined possible action included in a domain definition. Example interest criteria for an action property of an event include that the action be “play,” “delete,” “copy,” “access requested,” or “received.” Interest criteria for a target may include a predefined possible target included in a domain definition. For example, for a music domain, an acceptable target may include “album,” “track,” “playlist,” or the like. In some implementations, interest criteria for a target includes a particular target, such as a file, a graphical user interface element, an object, or so forth.

Interest criteria for a context of an event include clauses for distilling events based on their contextual properties. Context criteria can include a geographic location. For example, context criteria may include a latitude and a longitude that an occurrence for an event is to occur at for the event to be of interest for a subscriber application. Context criteria can include a time constraint for when an occurrence is to have happened, or other time constraints, for a subscriber application to be interested in an event for the occurrence. For example, context criteria may include raw start and end timestamps, within which an occurrence for which an event is created is to have occurred for a subscriber application to be interested in the event. In some implementations, context criteria include a time pattern query, which includes time patterns for when a subscriber application is to be provided an event meeting interest criteria for the subscriber application to be interested in the event. For example, a time pattern may include a recurring time range, such as every hour, every day at a particular time, a date, and so forth, that a subscriber application is interested in receiving an event meeting interest criteria. Similarly, context criteria can include other contextual information for events that are of interest to a subscriber application. For example, context criteria can include that a mobile device be at a predefined location for a subscriber application to be interested in an event that meets the interest criteria. A time pattern query may be expressed as a string in a traditional Cron format.

Interest criteria for an attribute of an event includes attributes for an event that a subscriber application is interested in receiving. Attribute criteria may include a list of key-operator-value tuples, where for each tuple a key is an attribute name, an operator is a comparison operator (e.g., “$eq,” “$ne,” “$lt,” “$gt,” “$le,” “$ge” “$matches,” “$contains”), and a value is a value for the attribute in question that is allowable in the range for the data type for that attribute.

An example JSON representation of a filter in an “email” domain may include the following:

```
{
  ″filter″: {
    ″id″: ″filter_1″,
    ″domain″: ″df-core.email″,
    ″target″: ″df-core.email.email″,
    ″action″: ″*″,
    ″context″: {
      ″location″: { ″lat″: 12.124, ″long″: 123.04, ″radius″: 25.0 },
      ″time_pattern″ : ″* * 25 12 * *″ /* Every year, December 25th */
    },
    ″attributes″: [
      { ″$matches″: {″from″: ″.*fedex.com″} },
      { ″$contains″: {″subject″: ″package″ } }
    ]
  }
}
```

This example filter includes interest criteria including domain criteria that an event belong to an email domain, “df-core.email.” The interest criteria include target criteria including that a target in an event be an email target, “df-core.email.email.” The interest criteria include action criteria including that an action property of an event be any action. Indeed, in some implementations, interest criteria include a value that denotes that a subscriber application is interested in an event that includes any value for a property of the event. This can be denoted in a filter by a predetermined value associated with a subscriber application being interested in any value, such as: “*”. The interest criteria include context criteria including that a location of a device be within a prescribed distance from a prescribed latitude and longitude when an event was created for the event to be of interest. Context criteria also includes that a time be any time on the date of December 25th of any year when an event was created for the event to be of interest. Attribute criteria include key-operator-value tuples indicating that an event is of interest if an email that is a subject of the event be from *fedex.com and have a subject that includes “package.”

A filter can include other components, including an identifier for the filter. In some implementations, the interesting event ID module creates an identifier for the filter and associates it with the filter. In some implementations, interest criteria include a condition that must be met for an event to be delivered to a subscriber application. For example, a condition included in a filter may include that an event is not from a predetermined data node. As another example, a condition included in a filter may include that an event be provided by a pre-approved data node. In some implementations, interest criteria include contract criteria, including an offer and/or advanced acceptance of an offer if the offer meets offer criteria, for a contract associated with being delivered events meeting interest criteria. For example, a contract associated with being delivered events may include that a subscriber application transfer a predetermined quantity of monetary value to a data node and/or the system for each event that it is provided. An offer criteria can include that the subscriber application permits the transfer of as much as a maximum amount of monetary value when an event meeting interest criteria is provided to the application.

The interesting event ID module 330 determines whether to subscribe an application for events meeting interest criteria. The interesting event ID module maintains a list of subscription requirements, and it determines whether a subscription requirement applies to a requested subscription, and if it does, whether the subscription requirement for the requested subscription is met. When subscription requirements for a requested subscription are met, or if no subscription requirements apply to the requested subscription, the interesting event ID module determines to subscribe an application requesting the subscription for events meeting requested interest criteria. A subscription requirement can be created by an administrator of the system, the security module 350, the privacy module 360, or the contracts module 370. Subscription requirements are stored in subscriptions data storage 265. Subscription requirements can be saved and maintained, for example, in a text file, or in a CSV formatted file.

The interesting event ID module evaluates whether a subscription requirement applies to a requested subscription. In some implementations, a subscription requirement includes criteria for a requested subscription that it applies to, and the interesting event ID module evaluates whether a subscription requirement applies to a requested subscription based at least in part on determining whether the criteria are met. Criteria for a requested subscription that a subscription requirement applies to may include that the subscription is not for an application that is in a predefined list of applications. For example, a subscription requirement may only apply to subscriptions for applications that are not known to the system. Criteria for a subscription that a subscription requirement applies to may include that the subscription is for an application that meets an application criteria. For example, a subscription requirement may only apply to subscriptions for music player applications. Criteria for a subscription that a subscription requirement applies to may include parameters for interest criteria for a subscription that the subscription requirement applies to. For example, a subscription requirement may only apply to a subscription for events that belong to an email domain. The interesting event ID module is configured to evaluate whether a subscription requirement applies to a requested subscription, and, if it does, apply the subscription requirement to the subscription. In some implementations, a subscription requirement applies to all subscriptions.

The interesting event ID module 330 determines whether a subscription requirement for a requested subscription is met. A subscription requirement may include any of a variety of requirements related to a requested subscription, and the interesting event ID module determines whether a requested subscription meets the subscription requirement based at least in part on a comparison between the subscription requirement and data pertaining to the subscription requirement. For example, for a subscription requirement that an application requesting a subscription be in a list of pre-approved applications, the interesting event ID module may compare the subscription requirement, including the list of pre-approved applications, with the application requesting the subscription.

The interesting event ID module 330 may rely on input from the security module 350, the privacy module 360, or the contract module 370, or input from a user received via the user interface module 380, in order to determine whether a subscription requirement is met for a requested subscription. For example, a subscription requirement may include that an application requesting a subscription provide security credentials that can be verified by the system. The interesting event ID module is configured to pass received security credentials to the contract module for verification.

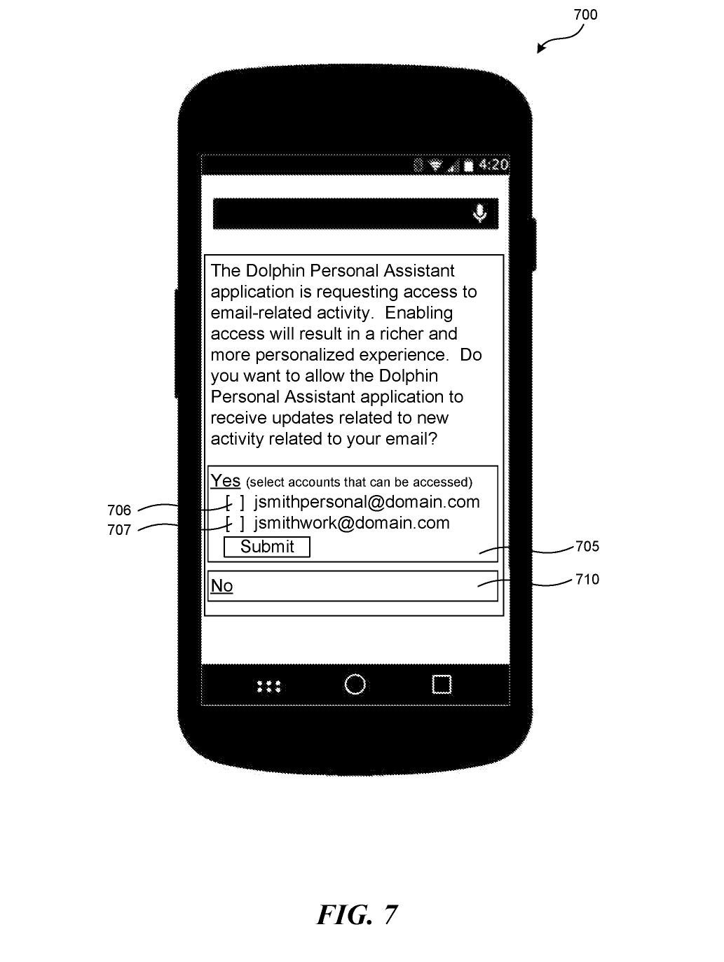

A subscription requirement for a requested subscription may include that a user has approved of the subscription. The interesting event ID module is configured to query the privacy module regarding whether user approval for allowing the subscription has been received. The privacy module, in conjunction with the user interface module 380, can generate a graphical user interface for display to a user, which includes an option for the user to select to approve of the subscription. FIG. 7 shows a mobile device 700 including a representative graphical user interface for requesting and receiving permission from a user to subscribe an application for events at data nodes. The graphical user interface includes a request for permission to receive events from data nodes comprising email applications. The system may receive a selection by a user of a yes option 705 or a no option 710. The yes option 705 includes fields that are each associated with different data nodes. A first field 706 is associated with a data node for a first email account and a second field 707 is associated with a data node for a second email account. The privacy module can receive a selection by a user via a graphical user interface generated by the user interface module of an option to allow a requested subscription, and the interesting event ID module 330 can approve of the subscription in response to receiving the user input via the privacy module. For example, referring to the example of FIG. 7, if a selection were received of the first field 706 and a submit button, the privacy module may approve of a subscription to events generated by a data node associated with the first email account but not to events generated by a data node associated with the second email account. As discussed further below, the interesting event ID module can modify a subscription to comply with subscription requirements or input from a user.

A subscription requirement for a requested subscription may include that a subscriber application has met its end of a bargain to a contract. The contracts module enforces contracts between and among data nodes, the system, a user, and subscriber applications. The interesting event ID module may request that the contract module determine whether a subscription requirement related to a contract is met for a received subscription. If a party to a contract has not met its contractual obligation for a subscription requirement, the contracts module instructs the interesting event ID module to not approve of a subscription. If a party to a contract has met its contractual obligation for a subscription requirement, the contracts module instructs the interesting event ID module to approve of a subscription. For example, a contract between a subscriber application and the system may include that the subscriber application register as a data node prior to being permitted to subscribe to interest criteria for events, and a subscription requirement may include that the contract is met for the subscription to be established. The interesting event ID module may determine that the subscription requirement is met when it receives an indication from the contracts module that the subscriber application is registered with the system as a data node. Contracts are stored in contracts data storage 395. Contracts may be received from a data node or from an administrator of the system.

A subscription requirement for a requested subscription may include that a subscriber application has taken an action that will enable it to meet a contractual obligation associated with the requested subscription. For example, a delivery action associated with events belonging to a predefined domain may include that a subscriber application that receives an event transfer monetary value from an account associated with the subscriber application to an account associated with a data node that provided the event and/or an account associated with the system. In order for a subscriber application to be able to meet its contractual obligation to transfer monetary value to the system and/or a data node when it receives an event belonging to the domain, a subscription requirement may include that the subscriber application first fund an account that the system is permitted to debit. The contracts module is configured to determine whether the subscriber application has taken a required action, and to notify the interesting event ID module regarding whether it has or not. For example, the contracts module may monitor an account associated with a subscriber application, from which monetary value may be debited, to ensure that the subscriber application has funded the account in order to meet its contractual obligation of paying for an event belonging to a domain associated with a delivery act comprising a payment.

If all subscription requirements for a subscription request are met, the interesting event ID module 330 determines to subscribe an application requesting the subscription for interest criteria included in the subscription request. In some implementations, if a subscription requirement for a requested subscription is not met, the interesting event ID module 330 rejects an application's subscription request. In some implementations, if a subscription requirement for a requested subscription is not met, the interesting event ID module modifies the subscription such that it meets the subscription requirement. For example, a subscription requirement may include a restriction on interest criteria that an application can subscribe for. The interesting event ID module is configured to modify interest criteria for a subscription such that it meets the restriction. As another example, referring again to FIG. 7, if a user were to select the first field 706 and not the second field 707, the privacy module may instruct the interesting event ID module to modify interest criteria for a subscription such that the interest criteria includes that an event must be received from the data node for the first field and not the data node for the second field. If a selection were received of the no option 710, the privacy module would not approve of a subscription by the application for events.

The interesting event ID module 330 creates and maintains a subscription list, which associates an application with interest criteria for events that the application is subscribed for. A subscription list can also include whether a subscription is active or inactive. A subscription list can be formatted, for example, in CSV format, and stored in subscriptions data storage 365. The interesting event ID module is configured to add an entry for a received subscription to a subscription list when it determines that subscription requirements for a subscription are met.

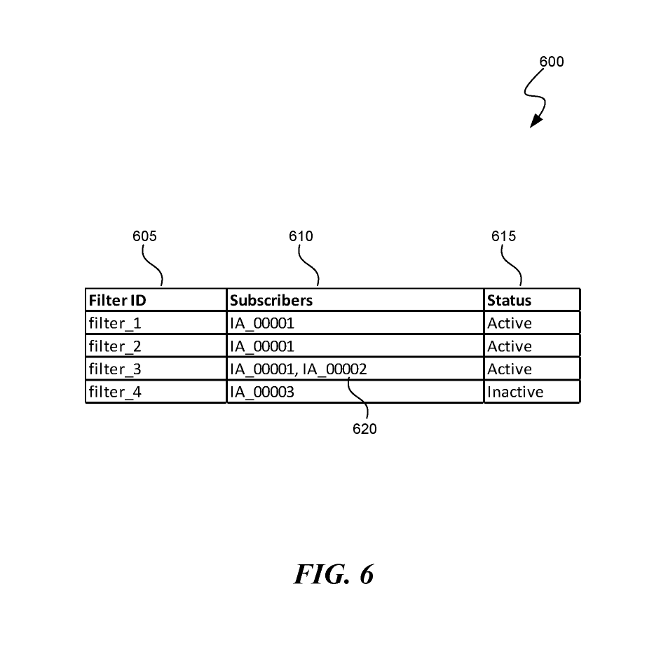

FIG. 6 shows a table 600 including an exemplary subscription list. The table includes a filter ID column 605, a subscribers column 610, and a status column 615. The filter ID column 605 includes identifiers for filters, the subscribers column 610 includes identifiers for subscriber applications, and the status column 615 includes a status for a subscription, either “active” or “inactive.” A first filter, filter_1, is associated with a first subscriber, subscriber IA_0001, and a status of this subscription for the first subscriber is “Active.” Accordingly, subscriber IA_0001 is subscribed for events meeting filter_1. Multiple applications can be subscribed for a same filter. The interesting event ID module is configured to subscribe an application for an existing filter. For example, a first application may have provided a filter in a request to subscribe for events provided by the system. The interesting event ID module 330 may assign an identifier to the filter, and another application wishing to subscribe to the filter can do so by referencing the identifier assigned to the filter in a subscription request. The interesting event ID module 330 is configured to consolidate subscriptions that include common filters. For example, the interesting event ID module can compare interest criteria of a filter received in a request by an application to subscribe for events with interest criteria of filters included in a subscription list. When interest criteria of a received filter matches interest criteria of an existing filter, the application wishing to subscribe to the filter can be subscribed to the existing filter. In the table 600, two applications included in cell 620 are subscribed to events meeting a same filter, filter_3.

The interesting event ID module 330 can deactivate an active subscription. In some implementations, the interesting event ID module determines to deactivate an active subscription based at least in part on receiving an instruction to deactivate the subscription from the security module 350, the privacy module 360, and/or the contracts module 370, or from a subscriber application. For example, the contracts module 370 may instruct the interesting event ID module to deactivate a subscription when it determines that the application has not performed on its end of a contract agreed to by the application, and, in response, the interesting event ID module 330 deactivates the subscription. In some implementations, the interesting event ID module 330 determines to deactivate an active subscription based at least in part on receiving from the event delivery control module 340 an indication that events received from the interesting event ID module for delivery to a subscriber application are not being delivered to the subscriber application. For example, the event delivery control module 340 may alert the interesting event ID module when it does not deliver an event received from the interesting event ID module to a subscriber. In some implementations, the interesting event ID module determines to deactivate an active subscription when a predetermined number of consecutively delivered events are not delivered to a subscriber application. The interesting event ID module can deactivate an active subscription by toggling a value associated with a status of the subscription from active to inactive.

The interesting event ID module identifies events of interest to a subscriber application from among events received from data nodes via the data nodes communication module 320. The interesting event ID module compares received events with interest criteria of an active subscription, and determines that an event is of interest to a subscriber to the active subscription when the event meets the interest criteria. The interesting event ID module provides events determined to be of interest to a subscriber to the event delivery control module 340 for delivery to the subscriber application.

The interesting event ID module 330 determines whether a received event meets interest criteria of a filter based at least in part on a comparison between the interest criteria and values of properties of the event. In some implementations, the interesting event ID module determines that a received event meets interest criteria of a subscription when it determines, based on comparing the interest criteria to the event, that the event includes properties whose respective values satisfy requirements of the interest criteria. For example, interest criteria of a subscription may include a value for each of a domain, a target, and an action, and the interesting event ID module can determine that a received event meets the interest criteria when the event includes values for a domain property, a target property, and an action property, respectively, that are equivalent to values in the interest criteria. In some implementations, if any interest criteria for a subscription are not met by an event, the interesting event ID module 330 determines that the event is not of interest to a subscriber application.

In some implementations, the interesting event ID module 330 is configured to include a query processor for determining whether an event is of interest to a subscriber application. In some implementations, the interesting event ID module determines that interest criteria of a filter are met by an event when it determines, based on comparing the interest criteria to the event, that the event includes properties whose respective values satisfy requirements of predetermined interest criteria of the filter and values included in an attribute property of the event are responsive to a query determined based on attribute criteria of the filter. For example, the interesting event ID module may compare values for a domain property, a target property, and an action property of an event with domain, target, and action criteria, respectively, of a filter, and if the values for the domain, the target, and the action properties meet the filter, the interesting event ID module may perform a query processing step based on a query determined using attribute criteria of the filter, determining that the event is of interest to a subscriber application when the event is responsive to the query.

The interesting event ID module 330 is configured to apply interest criteria of multiple filters in a hierarchical filtering process, under which an event is compared to similar interest criteria of different filters in successive stages. For example, under a hierarchical filtering process, the interesting event ID module may compare a received event first against respective domain criteria of multiple filters, second against respective target criteria of filters whose domain criteria are determined to have been met by the event in the first stage, third against action criteria of filters whose domain criteria and target criteria are determined to have been met, and so on, and eliminate a filter from consideration at any stage that interest criteria for the filter are not met by the event. The interesting event ID module can determine that an event is of interest to an application who is subscribed for interest criteria that are met at each stage of the analysis (except for a stage for which the interest criteria do not include a component). The interesting event ID module can account for duplicate interest criteria among multiple filters and compare duplicate interest criteria once to a received event. As an example in a hierarchal filtering process, for a scenario with five active filters that include domain criteria including that a domain for an event be “email,” “email,” “location,” “advertisement,” and “email,” respectively, the interesting event ID module can determine whether a domain property of the event meets domain criteria of the filters by comparing a value of the domain property of the event to domain criteria of the filters, including criteria for a domain of “email,” “location,” or “advertisement.” Provided the event includes a value of “email” for its domain property, the interesting event ID module compares the event to second interest criteria of active filters that include domain criteria including that an event be of a of an “email” domain. By using a hierarchical filtering process, the interesting event ID module 330 can reduce processing involved with comparing interest criteria of multiple filters to large volumes of events generated by data nodes.

In some implementations, the interesting event ID module 330 implements a hierarchical filtering process using observer chains and reactive extensions (e.g., RxJava, RxAndroid) for a pipelined design. The interesting event ID module passes an event from a stage of a matching pipeline to a subsequent stage if it determines that the event matches an event criteria of a filter in the original stage. A downstream stage in the matching pipeline subscribes, as in RxJava, to a previous stage and only processes an event that makes it to its stage. A final stage includes a query processor that evaluates an attribute property of an event that reaches this stage, based on a query identified based at least in part on attribute criteria of the filter.

The interesting event ID module 330 determines that an event is of interest to a subscriber application if the event meets interest criteria that the application is subscribed for. When an event is determined to be of interest to a subscriber application, the interesting event ID module provides the event to the event delivery control module. The interesting event ID module may provide the event delivery control module with an event identifier for an event that has been determined to be of interest to a subscriber application, and an identifier for the subscriber application that the event is to be delivered to.

The event delivery control module 340 receives events for delivery from the interesting event ID module 330. The event delivery control module regulates whether and when events provided by the interesting event ID module are given to a subscriber application. The event delivery control module 340 creates and maintains an event delivery list, which includes entries for events including information for their delivery. The list can be used for tracking, controlling, and prioritizing delivery of events to subscriber applications.

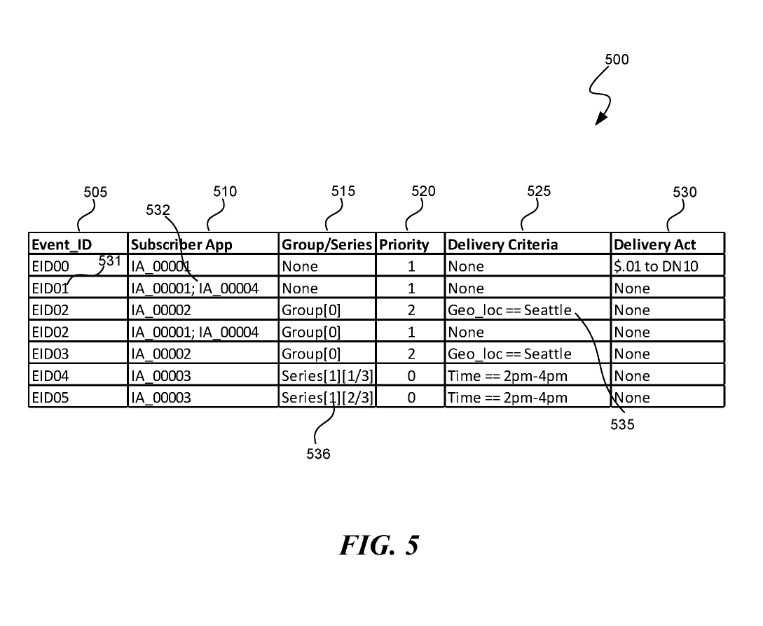

An event delivery list is populated with events received from the interesting event ID module 330. For an entry added to an event delivery list, the event delivery control module 340 adds at least an identifier for the event and an identifier for a subscriber application that is to receive the event. An identifier for a subscriber application is received from the interesting event ID module. An event delivery list is stored in events data storage 375. An event delivery list can be stored in any of various formats, such as comma separated values format. In some implementations, the event delivery list is a priority queue. FIG. 5 shows a table 500 depicting an event delivery list that includes events that are prioritized for delivery to subscriber applications. The table 500 includes columns for an event identifier 505 and a subscriber application identifier 510. A value in the subscriber application column 510 includes an identifier for a subscriber application that an event is to be delivered to. For example, a subscriber application cell 532 includes identifiers for subscriber applications that are to be provided an event in an event identifier cell 531.

An entry in an event delivery list can include delivery information for an event, which may include group or series information for an event, priority information for an event, delivery criteria for an event, and delivery acts for an event. The event delivery control module 340 adds delivery information to an entry in an event delivery list. The table 500 of FIG. 5 includes columns for a group or series identifier 515, a priority 520 for an event, delivery criteria 525 associated with delivering an event, and delivery acts 530 associated with an event.

The event delivery control module 340 can determine group or series information for an event based on a value for a group or series property of the event. In some implementations, the event delivery control module delivers an event in a position in an order relative to other events that is chosen based at least in part on a group or series value associated with the event. For example, series information in cell 536 includes that an event is a second in a series of three events, and series information in a cell above cell 536 includes that an event is a first in the series. The event distillation system can refrain from delivering the second event of the series until after it delivers the first event of the series.

The event delivery control module 340 can prioritize delivery of some events over the delivery of others. In some implementations, the event delivery control module adds priority information for an event to an event delivery list. Priority information for an entry in an event delivery list may be selected based at least in part on a value included in a priority property of an event. The event delivery control module is configured to normalize priority information across events. The event delivery control module can prioritize delivery of events for various reasons and can change priority information for events at any time. In some implementations, the event delivery control module throttles delivery of events in order to reduce power consumption of a device, and the event delivery control module prioritizes delivery of a higher priority event over delivery of a lower priority event. In some implementations, the event delivery control module throttles delivery of events to a particular subscriber application. For example, the event delivery control module may deprioritize delivery of events to a subscriber application that has been delivered an inordinate percentage of events generated by data nodes. An inordinate percentage of events may be a threshold percentage of events over a predefined time period. In some implementations, the event delivery control module prioritizes an event for immediate delivery to an application. For example, an event generator may add context information indicative of an emergency to an event, and the event delivery control module can assign a priority to an entry for the event in an event delivery list associated with immediate delivery to a subscriber application. In the event delivery list of the table 500, events are prioritized on a scale ranging from zero to two, with zero being associated with greater priority for more immediate delivery and two being associated with a lowest priority.

The event delivery control module 340 can deliver an event to a subscriber application when delivery criteria are met. Delivery criteria include requirements that are to be met for an event to be delivered to a subscriber application. Delivery criteria are stored in delivery criteria data storage 345. Delivery criteria can be stored, for example, in CSV format. Delivery criteria can be provided by the event delivery control module 340, the interesting event ID module 330, the security module 350, the privacy module 360, or the contracts module 370. In some implementations, delivery criteria are provided by an administrator of the system 200. In some implementations, delivery criteria are included in an event. Indeed, a domain definition may include a property for delivery criteria, and a data node can add delivery criteria to an event. Delivery criteria received by the event delivery control module can be added to a delivery criteria list stored in delivery criteria data storage 345.

The event delivery control module 340 is configured to determine whether delivery criteria apply to a delivery of an event to a subscriber. Delivery criteria can include criteria for the event delivery control module to evaluate in order to determine whether the delivery criteria apply to a delivery of an event. In some implementations, the event delivery control module evaluates whether delivery criteria apply to a delivery based at least in part on a comparison between an event and delivery criteria presently being enforced by the system. For example, criteria for determining whether delivery criteria apply to a delivery may include that an event being delivered belongs to a predefined domain for the delivery criteria apply. In some implementations, the event delivery control module evaluates whether delivery criteria apply to a delivery based at least in part on a comparison between environmental conditions and delivery criteria presently being enforced by the system. For example, delivery criteria may apply only to a delivery of an event when a device is determined to be at a predefined geographic location, to a delivery of an event when a current time is within a predefined time range, to a delivery of an event when battery power for a device is below a predetermined threshold, or the like. In some implementations, the event delivery control module evaluates whether delivery criteria apply to a delivery based at least in part on a comparison between delivery criteria and a subscriber application that an event is to be delivered to. For example, delivery criteria may apply only to a delivery of an event to a predefined subscriber application. The event delivery control module can evaluate whether delivery criteria apply to a delivery based at least in part on a comparison between delivery criteria and other types of data that pertain to whether delivery criteria apply to a delivery. In some implementations, a delivery criterion applies to all deliveries of events by the event delivery control module. Delivery criteria that apply to an event are added to an entry for delivery of the event in an event delivery list.

The event delivery control module 340 can access and maintain a delivery criteria list including active and inactive delivery criteria. The event delivery control module may add received delivery criteria to the delivery criteria list. The event delivery control module references the delivery criteria list to identify delivery criteria that might apply to delivery of an event. The event delivery control module can activate or deactivate delivery criteria based at least in part on input from the interesting event ID module 330, the security module 350, the privacy module 360, or the contracts module 370; or based on input from a user, a data node, or from an administrator of the system.

The event delivery control module 340 is configured to determine whether delivery criteria are met based on received device/user data and/or input from at least one of a user, a subscriber application, or a data node. For some delivery criteria, the event delivery control module can determine whether the criteria are met based at least in part on input from the security module, the privacy module, and/or the contracts module. In some implementations, the event delivery control module requests of the security module 350, the privacy module 360, or the contracts module 370 that it inform the event delivery control module when a delivery criterion is met, and the event delivery control module determines that the delivery criterion is met when it is informed that the delivery criterion is met.

Delivery criteria can include environmental restrictions for delivering an event. Delivery criteria can include time restrictions. Delivery criteria may include that an event only be delivered at a predetermined time, at a time that is selected relative to an event, or prior to a predetermined time, and the event delivery control module can determine whether delivery criteria are met based on a comparison between a current time and the delivery criteria. Delivery criteria can include geographic restrictions for delivering an event. Delivery criteria may include that an event only be delivered when a user's mobile device is within a particular jurisdiction, such as a particular country, and the event delivery control module can determine that the delivery criteria are met when received device/user data includes geographic information indicative of the mobile device being within the prescribed jurisdiction.

Delivery criteria can include that a user has approved of delivery of an event. For example, delivery criteria can include that a user be alerted via a GUI generated by the user interface module that an event may be delivered to a subscriber application with permission from the user, and that permission be received via the GUI to deliver the event to the subscriber application. Delivery criteria can include that a subscriber application fulfill its end of a bargain to a contract before an event is delivered, and the event delivery control module delivers the event to the subscriber application when the event delivery control module receives a message from the contracts module that the contract has been fulfilled. For example, a contract between a data node and a subscriber application may include that the subscriber application pay a data node $0.001 for each event that the subscriber is delivered under a particular filter, and a delivery criteria may include that the subscriber application not have a negative account balance so that the subscriber application can pay the data node for delivery of an event. The event delivery control module may deliver an event for which this delivery criteria applies when it confirms that the subscriber application does not have a negative account balance.

An event delivery list can include events whose delivery criteria are met and events whose delivery criteria have not yet been met. In some implementations, the event delivery control module 340 does not add an event to the event delivery list when it determines that it is impossible for delivery criteria for the event to be met. The event delivery control module can remove entries for events from the event delivery list when it determines that it is impossible for delivery criteria to be met for those events. For instance, an event may be associated with delivery criteria including that the event only be delivered when a user device is in a predetermined geographic region during a predetermined time period. The event delivery control module adds the event to the event delivery list if a current time is within the predetermined time period and the user device is in the predetermined geographic region, or the time period has not yet passed. The event delivery control module may periodically check whether delivery criteria are met for delivery of an event.

The event delivery control module 340 is configured to deliver events out of an event delivery list to subscriber applications. An event included in an entry in an event delivery list is ripe for delivery when all delivery criteria are met or no delivery criteria apply to delivery of the event. In some implementations, the event delivery control module automatically delivers an event that is ripe for delivery to a subscriber application. In some implementations, the event delivery control module does not deliver an event automatically if delivery criteria are met for delivering the event. In some implementations, an event delivery list is a priority queue, and the event delivery control module delivers events that are associated with a higher priority before events associated with a lower priority, and if two events are associated with a same priority, the event deliver control module delivers an event associated with an entry in a higher spot in the list over an event associated with an entry in a lower spot. The event delivery control module may add entries for new event deliveries at a bottom of the event delivery list and delete an entry for a delivery of an event when the event has been delivered.

The event delivery control module 340 is configured to limit a rate that it delivers events. When throughput for delivery of events is limited, the event delivery control module may prioritize the delivery of some events over the delivery of others. In some implementations, the event delivery control module delivers a predefined maximum quantity of events over a predefined time period. For example, the event delivery control module may limit delivery of events to 1000 events delivered every minute. In some implementations, the event delivery control module delivers events to subscriber applications in groups of events at consistent time intervals. For example, the event delivery control module may constrain itself to delivering 100 or fewer events from an event delivery list every five seconds. In some implementations, the event delivery control module throttles delivery of events based at least in part on determining that a battery power of a device is below a predefined threshold. The event delivery control module may deliver an event to a subscriber application by providing the subscriber communication module 310 with an event identifier and an identifier for a subscriber who the event is to be delivered to.

The event delivery control module 340 is configured to perform an action or have an action performed in response to delivering an event to a subscriber application, or in response to delivering supplemental data for an event. The event delivery control module can add a delivery act to an entry for an event in an event delivery list. For example, in the table 500 of FIG. 5, a delivery act for an event, EID00, includes “$0.01 to DN10,” which may be understood as an instruction to transfer $0.01 to a data node, DN10, when the, EID00 is delivered to subscriber application, IA_00001. The event delivery control module is configured to commence or cause, in conjunction with the contracts module, a transfer of monetary value from an account associated with a subscriber application receiving an event to an account associated with an administrator of the system, an account associated with a data node, and/or an account associated with a user, as a delivery act dictates, or to release monetary value from escrow as dictated by a delivery act. Delivery acts can be provided by the contracts module 370, by a user, by an administrator of the system, or by a data node providing an event that is being delivered. A delivery act can apply to events meeting a criterion, such as to all events that are delivered to a particular subscriber application, or to all events that are of a particular domain. A data node can provide a delivery act in an event. For example, a domain definition may include a price property for events of a domain, and events of the domain that are generated by a data node may include a price that it is to be paid by a subscriber application when the event is delivered to the subscriber application. In subscribing for a filter, the subscriber application may include interest criteria that includes a price limit that the subscriber is willing to pay for an event form a data node. When interest criteria are met and the event is delivered, the event delivery control module causes a transfer of the price specified in the event from the subscriber to the data node.

The event delivery control module 340 is configured to commence the transfer of supplemental data to a subscriber application when a request is received from the subscriber application for the supplemental data. As discussed throughout, an event may reference supplemental data that a subscriber application can request from the system. After the event is delivered to a subscriber application, the event delivery control module may receive a request for supplemental data from the subscriber. The event delivery control module can instruct the subscriber communication module to deliver the requested supplemental data, which may be cached by the system or requested from a data node. A delivery act for an event may apply to delivery of supplemental data. For example, a domain definition may provide for an event property including a price to be paid to a data node for delivery of supplemental data associated with an event. The event delivery control module may add to an entry in an event delivery list a delivery act for supplemental data. When it delivers the supplemental data, the event delivery control module can take the delivery act. For example, the event delivery control module can debit an account associated with a subscriber application and credit an account associated with a data node to fulfil a delivery act including that the data node be paid money when supplemental data is delivered to a subscriber application.

The security module 350 ensures that subscriber applications that are unauthorized to receive events are not provided events by the system. The security module may create delivery criteria or subscription requirements based on input from a data node, a user, or an administrator of the system, and the security module evaluates the delivery criteria and subscription requirements that it creates.

The security module is configured to verify a subscriber application based on security credentials provided by the subscriber application. Received security credentials can be compared against stored security credentials to verify a subscriber application. For example, a subscription requirement may include that an application have an account registered with the system in order to subscribe for events. The security module can verify received security credentials, such as a username and password, when they are associated with an account registered with the system.

The security module is also configured to authenticate a subscriber application. For example, delivery criteria for delivery of an event may include that a subscriber application have an account registered with a data node providing the event. The subscriber application can provide the system with an access token that it has received from the data node, and the security module can verify the authenticity of the access token, either based on data stored in permissions data storage 385 or based on the data node verifying the authenticity of the access token. When the access token is authenticated, the event delivery control module 340 can determine that the delivery criteria are met. In some implementations, an access token is associated with a user's account with a data node. For example, delivery criteria may include that an event only be delivered to a subscriber application that provides an access token associated with a user's account at a data node. A data node may provide a subscriber application with an access token associated with a user's account at the data node after the user has provided security credentials to the data node and permission for the subscriber application to receive events from the data node. In some implementations, an access token is an OAuth token. A data node may require that a subscriber application provide authentication information for a number of different applications. For example, a data node may include a banking application, and the banking application may wish to only provide events to trusted partners. The security module accesses security information and other data in permissions data storage 385.

The privacy module 360 protects a user from having an event shared that a user wishes to not have shared. The privacy module can create delivery criteria and subscription requirements that restrict delivery of an event to a subscriber if a user has not provided permission for the delivery. The privacy module instructs the user interface module to generate user interfaces for requesting and receiving permission from a user for various reasons. User permission may be requested for providing events from a data node, for providing events to a subscriber application, for providing an event from a data node that meets predefined criteria, and the like. For example, user permission may be requested when a new data node requests to provide events to the system, and the privacy module can create delivery criteria that prohibits delivery of events from the new data node until user permission has been received.

The privacy module maintain a list of user permissions in permissions data storage 385. The list may include identifiers for data nodes that have been approved of by a user for providing events, identifiers for subscriber applications that have been approved of by the user for receiving events, event properties for events that the user has approved of being delivered to a subscriber application or provided by a data node (e.g., a domain for events that are approved of), and the like. The privacy module also maintains a list of things that user has refused to provide permission for. For example, the privacy module may maintain a list that includes subscriber applications that are not permitted to receive events, data nodes that are not permitted to provide events, and the like. The privacy module may reference a list of user permissions and a list of things a user has refused to provide permission for in order to determine whether delivery criteria or subscription requirements are met. The privacy module may add an entry to one of these lists when user permission is requested of a user for a particular reason.

The contracts module 370 enforces contracts between parties to the system. Contracts may be between or among a user, a subscriber application, a data node, and the system. Contract provisions are received from a data node, a subscriber application, a user, or an administrator of the system. The contracts module is configured to form a contract. The contracts module is also configured to determine whether a party to a contract has met its end of the bargain. In some implementations, the contracts module takes an act associated with performance by a party with regard to its end of a contract. The contracts module creates delivery criteria and subscription requirements based on a contract, and can evaluate whether delivery criteria or subscription requirements that it creates are met.

Contracts between parties to the system may be for any sort of agreement related to the delivery of events. The contracts module is configured to facilitate formation of a contract between parties. The contracts module can receive contract provisions from a party to a contract and provide the contract provisions to another party to the contract. The contracts module is also configured to receive a promise from a party to perform on its end of a bargain.

The contracts module can determine that a contract is formed when both sides to a contract agree on its provisions. For example, the contracts module may receive a request by a data node to provide events to the system. The data node may request that it be paid a predetermined fraction of a penny for each event that the data node provides to the system that is delivered to a subscriber application. The subscriber application may create delivery criteria that apply to all events provided by the data node, which include that a subscriber application agree to transfer the predetermined fraction of a penny to the data node when it is provided an event from the data node. The contracts module may determine that events from the data node would be delivered to a subscriber application except that the subscriber application has not agreed to transfer the predetermined fraction of a penny to the data node when it is provided an event from the data node. The contracts module may provide a message to the subscriber application that it would receive events from the data node if it would be willing to transfer the predetermined fraction of a penny to the data node for each event that is delivered. The contracts module may receive the subscriber application's assent to transfer the predetermined fraction of a penny to the data node for each event that is provided to the subscriber application from the data node under a subscription held by the subscriber application. The contracts module instructs the event delivery control module that delivery criteria related to a subscriber application providing payment to the data node are met for delivery of such events to the subscriber application, and the event delivery control module can deliver the events from the data node to the subscriber application.

The contracts module 370 is configured to take a contract action in response to performance by a party with regard to a contract. The contract action can be taken for execution of a delivery act associated with delivering an event. The contract action may include transferring monetary value from an account associated with a first party, or from an escrow account, to an account associated with a second party. In some implementations, the contracts module has access to or control over financial accounts associated with a subscriber application, a data node, the system, and/or a user, and the contracts module is configured to cause monetary value to be transferred between or among the accounts, debiting and crediting the accounts appropriately.

The contracts module can transfer monetary value using a cryptocurrency. In some implementations, the contracts module 370 is configured to cause a unit of account of a cryptocurrency, such as Bitcoin, to be transferred from a cryptocurrency address associated with a first party to a cryptocurrency address associated with a second party. For example, a subscriber application may be associated with a multisignature cryptocurrency wallet for which the system holds a private key and the subscriber application holds a private key. An event delivered to the subscriber application may include a delivery act that is to be performed if the subscriber application requests to receive supplemental data for the event. The delivery act may include that the subscriber application permit the transfer of a predetermined fraction of a unit of account of the cryptocurrency from the multisignature cryptocurrency wallet to a cryptocurrency address for which a data node providing the supplemental data holds the private key. The contract module may infer that the subscriber application agrees to the transfer of cryptocurrency in exchange for being provided the supplemental data when the subscriber application requests the supplemental data and submits the private key that it held to the multisignature wallet. The contract module can submit the private key that it holds to the multisignature wallet and instruct that the transfer be completed. In some implementations, the contract module monitors a cryptocurrency address, or employs a third party block observer to do so, in order to determine whether a transfer has been received at the address. The contracts module may determine that a party to a contract has met its end of the bargain when an expected transfer is observed to have been executed with respect to the address. The contracts module can store private keys for a cryptocurrency address in contracts data storage 395. The contracts module may also store a cryptocurrency wallet file in contracts data storage.

The following are some example contracts that the contract module can enforce, perform on, or observe the performance of: a contract between a subscriber application and the system that the subscriber transfer monetary value to the system for being allowed a subscription for events; a contract between a subscriber application and a user including that the subscriber transfer monetary value to the user for being allowed a subscription for events; a contract between a subscriber application and the system and/or a user including that the subscriber transfer monetary value to the system and/or the user, as required by an event that is delivered to the subscriber application, in exchange for the delivery of the event or in exchange for delivery of supplemental data for the event; a contract between a data node and the system and/or a user including that the system and/or the user transfer monetary value to the data node in exchange for the data node providing events; and a contract between a data node and a subscriber including that the subscriber transfer monetary value to the data node for an event provided by the data node, or for being allowed a subscription for events by the data node.

The user interface module 380 generates graphical user interfaces for display to a user for conveying information and receiving user input as described throughout this paper. The user interface module can process and provide user input to other modules of the system. The user interface module can generate a GUI when it receives an instruction to do so from another module of the system 200. The user interface module can generate interfaces for requesting permissions from a user. The user interface module can create graphical user interfaces using template graphical user interfaces stored in templates data storage 335.

The user interface module 380 can generate an interface for requesting a user's permission to allow a data node to provide events to the system. For example, the user interface module may receive from the interesting event ID module a request that permission from a user be requested for an application to act as a data node and provide events to the system. The user interface module can generate an interface for requesting permission from a user to allow an application to subscribe for events. For example, the privacy module may instruct the user interface module to obtain permission from a user to provide events meeting interest criteria to an application. FIG. 7 shows a representative GUI 700, generated by a mobile device based on GUI data provided by the user interface module, for requesting permission from a user to provide events to an application. The GUI 700 includes an explanation of the sort of data that the event dissolution system will provide to the subscriber application. A user can select a yes option 705 for permitting the system to provide events to the application and a no option 710 for denying permission. The yes option 705 includes a first field 706 associated with a first email account and a second field 707 associated with a second email account. A user can select one or both of the first and second fields and a submit button to provide permission to the system to provide events associated with an email account of a selected field to the requesting application. The user interface module can process a received input by a user to identify whether a selection has been received to grant permission to the system to provide events to the requesting application, and, if so, what account(s) the requesting application is permitted to receive events from. Received user input can be used for modifying a filter or a subscription. For example, the user input module may receive user input of a selection of the first field 706 and not the second field 707. The user input module can provide the interesting event ID module with the user input, and the interesting event ID module can modify a filter for a subscription for the requesting application such that the requesting application is not subscribed for events related to the second email account but is subscribed for events related to the first account.

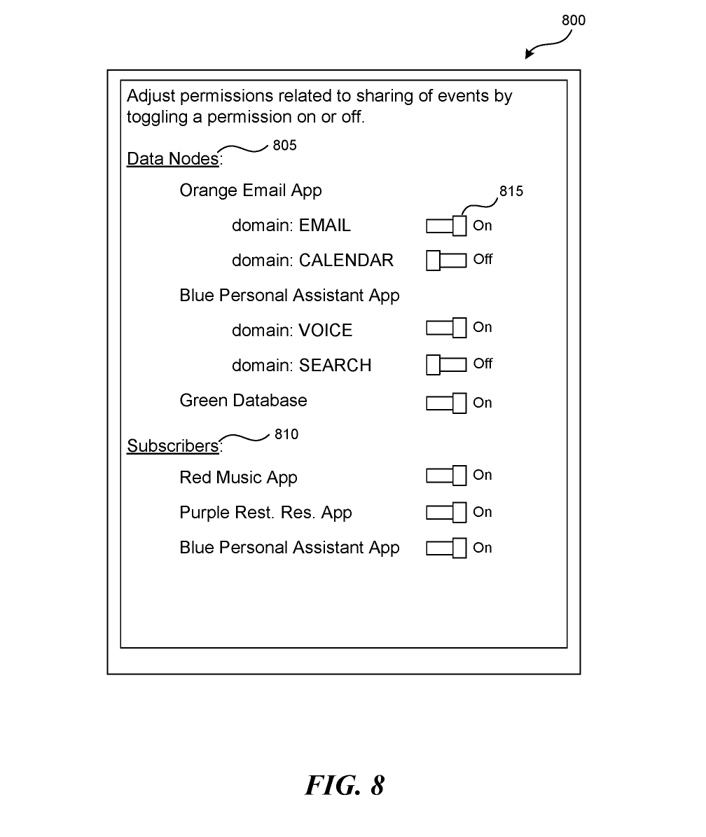

The user interface module can generate other graphical user interfaces for receiving permissions preferences from a user. FIG. 8 shows a representative graphical user interface 800, generated by the user interface module, for enabling a user to quickly grant or withdraw permissions related to data nodes providing events and subscriber applications being provided events. A data nodes list 805 includes data nodes providing events for distribution to subscriber applications. A subscribers list 810 includes applications that have subscribed for events (including those whose subscriptions are inactive). Toggle switches 815 are displayed next to listed data nodes and subscriber applications. The user interface module may receive user input of a selection of a toggle switch and provide the user input to the interesting event ID module, which can adjust a subscription for an application or a relationship with a data node in accordance with the received user input. The user interface module can generate user interfaces for enabling various levels of control for a user to adjust permissions. For instance, the subscribers list 810 includes an option to grant or deny permission for subscriptions for a subscriber application generally, and if user input is received of a selection to toggle a toggle switch to withdraw permissions for a subscriber application, the interesting event ID module can deactivate all subscriptions for the subscriber application. The data nodes list 805 includes toggle switches for turning on and off delivery of events meeting different interest criteria from a data node. For example, the user may select to permit an email app to provide events belonging to an email domain but not events belonging to a calendar domain. In some implementations, the user interface module generates a user interface for allowing a user to modify interest criteria of a subscription.

### Example Processes

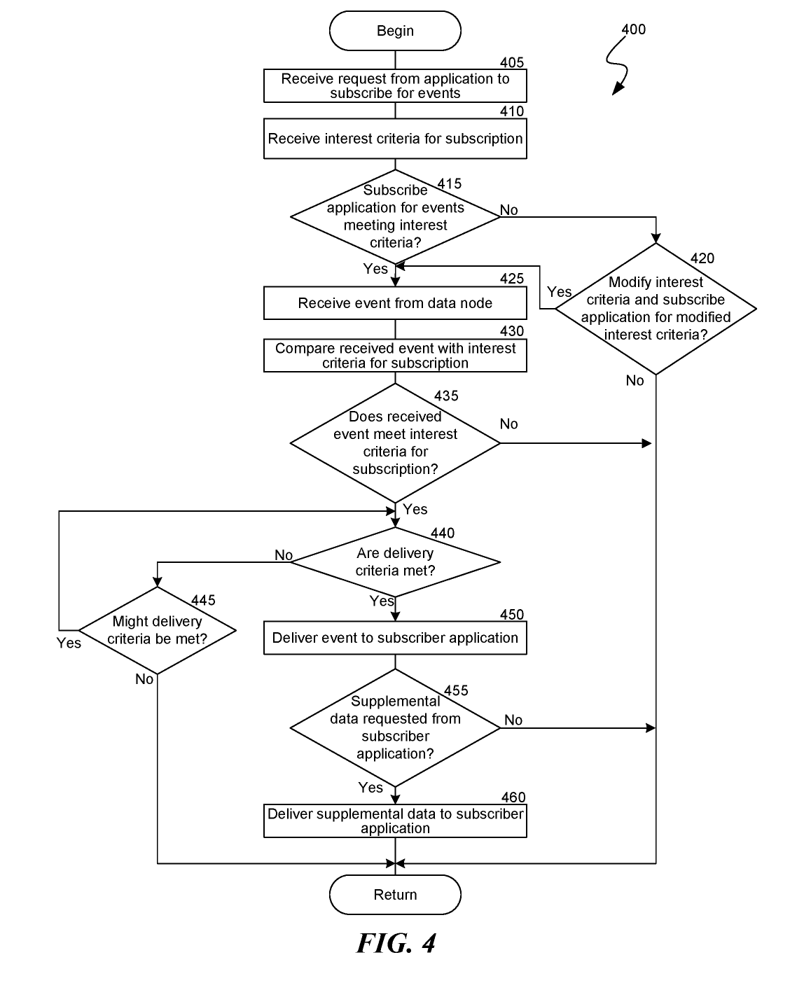

FIG. 4 is a flow diagram of a process 400 performed by the event distillation system 200 for subscribing an application to receive events meeting interest criteria, identifying events meeting the interest criteria for the subscription, and for delivering to the subscriber application an event that is determined to be of interest to the subscriber application. The process can be used for distilling events that a subscriber application will be interested in from among an effectively continuous stream of events generated by various data nodes. The process enables a subscriber application to learn information about occurrences at data nodes that the application is interested in. A data node can register with the system to provide events. The event distillation system 200 can be implemented, for example, in a mobile device 105, a data node may comprise an application running on the mobile device, a subscriber application may include an application running on the mobile device, and a user may be a user of the mobile device. The event distillation system can provide domain definitions to applications interested in subscribing for events and to data nodes.

At a block 405, the system 200 receives from an application a request to subscribe for events. The application may be an intelligent personal assistant application, a restaurant reservation application, a ride sharing application, parcel tracking application, an autonomous vehicle navigation system, or so on. The system may receive the request from the subscriber application during an installation process for the application, during an update process for the application, as a result of a predefined occurrence on a device or to a user, or the like. For example, an occurrence on a device can include that a new third party application has been installed or a new data node has become available. In some implementations, the request is received in user input instructing the system to provide events to an application interested in being provided events. For example, the system may generate a GUI that lists applications that are configured to be provided events by the system, and the system may receive a selection by a user of an application that the user wishes to receive events.

At a block 410, the system 200 receives interest criteria for events that the application is interested in being provided. Interest criteria can be received from the application interested in subscribing for events. In some implementations, the request by the application interested in subscribing for events includes a filter or references a filter that includes interest criteria and which is known to the system.

At a decision block 415, the system 200 determines whether to subscribe the application for events meeting interest criteria requested by the application. In some implementations, the system automatically subscribes an application for events meeting requested interest criteria. In other implementations, the system determines to subscribe an application for events meeting interest criteria if subscription requirements are met. The system decides whether any subscription requirements apply for the subscription request. The system compares the subscription request, including an identifier for the application requesting the subscription and interest criteria for the subscription, to a subscription requirement to determine whether the subscription requirement applies to the subscription request. Subscription requirements can include an identifier for an application or criteria for an application that the requirements apply to. For example, a subscription requirement may include a list of identifiers for applications that the subscription requirement applies to. As another example, a subscription requirement may include a criterion that an application be a particular type of application (e.g., a mapping application) for the subscription requirement to apply to the application. A subscription requirement can apply to all subscription requests. A subscription requirement can apply to all subscription requests that include a predetermined interest criteria. For example, a subscription requirement can apply to all subscription requests that request predetermined domain criteria.

When a subscription requirement is determined to apply to a subscription request, the system determines whether the subscription requirement is met. In some implementations, a subscription requirement includes that the system receive permission from a user to subscribe the application for the interest criteria. The system can determine that the subscription requirement has been met when the system receives user input associated with providing permission for the system to subscribe the application for the interest criteria. For example, the system may generate a graphical user interface for display via a display of a device, including a description of interest criteria or events that would be delivered to an application if it were subscribed for requested interest criteria. The graphical user interface can also include a request that a user provide consent for the described events to be shared. The system can receive user input providing permission. In some implementations, user input providing permission for a subscription is received prior to an application requesting a subscription. For example, the system can generate a user interface for soliciting permission from a user to establish a subscription for pre-identified interest criteria, or subscriptions generally, when a subscription is requested.

A subscription requirement can include that an application requesting a subscription meet its end of a bargain to a contract. For example, a subscription requirement may include that an application transfer monetary value to the system, an administrator of the system, a user, a third party, a data node, or the like, in order to subscribe for interest criteria. A contract between the system and an application may include that the application meet earlier obligations to the system, a user, a data node, a third party, or the like. For example, a contract between the system and an application for an earlier-established subscription may include that the application transfer monetary value to the system as a result of the system providing an event to the application. The system may subscribe the application for the requested subscription when the application performs on its earlier obligation. In some implementations, a subscription requirement includes that a subscriber application transfer monetary value to the system for a subscription to be established. The system may charge subscriber applications to subscribe for events, and the system can charge a flat fee, by the event that is delivered, or by a time that the subscription lasts for.

A subscription requirement can include that an application requesting a subscription provide security credentials that are validated prior to establishing the subscription. In some implementations, security credentials are for authenticating the application. For example, an application can be authenticated to ensure that the application is not an imposter. In some implementations, security credentials are for verifying that the application is permitted to receive events that are privileged or private. For example, a data node may provide privileged events that are only to be provided to an application that provides security credentials for a user, such as an authentication token. Upon being presented the security credentials by the application, the system may provide the data node with the security credentials. The data node can verify the authenticity of the security credentials, and the system may receive from the data node an approval of the application for receiving privileged events. When security credentials for a subscription requirement are validated, the system can determine that the subscription requirement has been met.

Multiple subscription requirements can apply to a subscription request by an application. In some implementations, the system determines that subscription requirements have been met when all subscription requirements that are determined to apply for a subscription are determined to have been met. When the system determines that subscription requirements that apply to a subscription have been met, or that no subscription requirements apply to the subscription, the system subscribes the application for requested interest criteria for events, and the process proceeds to a block 425. In some implementations, the system determines that subscription requirements are not met if any of the subscription requirements that apply to a subscription are not met. When subscription requirements are not met, the system determines to not subscribe an application for requested interest criteria for events, and the process 400 proceeds to a decision block 420.

At decision block 420, the system determines whether to modify requested interest criteria and subscribe the application for the modified interest criteria. Some subscription requests can be modified automatically by the system to meet subscription requirements. For example, a subscription requirement may include a bounds that an interest criterion of a subscription must fall within, and the system modifies the interest criterion so that it is within the bounds. For example, a bounds for interest criteria included in a subscription requirement may include that events be created by a data node within a predetermined time range. If interest criteria requested by an application includes no context criteria related to a time range that events are to be gathered, the system can add context criteria to the interest criteria, limiting events delivered for the subscription to those that are generated within the time range identified by the subscription requirement. Some subscription requests cannot be automatically modified to meet subscription requirements. For example, in some implementations, a subscription request that fails to meet a subscription requirement that a requesting application be in a list of applications approved to subscribe for events may not be automatically remedied by the system by modifying interest criteria for the subscription.

In some implementations, the system 200 determines whether to modify requested interest criteria and subscribe the application for the modified interest criteria based at least in part on user input. User input can include interest criteria, or user input may be used for modifying requested interest criteria. For example, a subscription request may not meet subscription requirements because a user has not provided permission for a requesting application to subscribe for requested interest criteria. The system can generate a user interface for receiving input from a user of interest criteria that the user permits the application to subscribe for, and the system modifies requested interest criteria so that it agrees with the interest criteria received from the user. In some implementations, the system 200 determines whether to modify requested interest criteria and subscribe the application for the modified interest criteria based at least in part on receiving modified interest criteria from a requesting application. The system may provide a message to an application detailing deficiencies in a subscription request received from the application. The message may identify interest criteria that the subscription request does not meet, according to subscription requirements. The system may receive new or modified interest criteria for a subscription from the application and subscribe the application for the received interest criteria, provided the interest criteria meet subscription requirements. If the system determines to not subscribe the application for modified interest criteria, the process 400 returns. If the system determines to subscribe the application for modified interest criteria, the system establishes a subscription for the application for the modified interest criteria, and the process proceeds to block 425.

At block 425, the system receives an event from a data node. The event can be generated by the data node in response to determining that an action has occurred. In some implementations, the system receives the event in a group of events provided by the data node. For example, a data node can cache events for delivery to the system, and the data node can provide multiple events from the cache in a package of events.

At a block 430, the system 300 compares the received event to interest criteria of active subscriptions. The system compares interest criteria with event properties and values for the event properties. The system can compare an endless stream of events provided by data nodes to interest criteria of active subscriptions. In some implementations, the system compares a received event to interest criteria of multiple filters arranged in hierarchal stages.

At a decision block 435, the system determines whether the received event meets interest criteria of the subscription. The system determines that the received event meets interest criteria when values for properties of the event are within values prescribed by the interest criteria. In some implementations, the system determines that an event meets interest criteria when a predetermined subset of interest criteria are met by an event, and other interest criteria are responsive to a query. For example, the system may determine that an event meets interest criteria of a filter if respective values for a domain property, an action property, and a target property meet interest criteria directed to these properties, and an attribute property for the event includes a value responsive to a query created based on attribute criteria for the filter. When the system determines that interest criteria are not met, the process 400 returns. The system can discard events that do not meet interest criteria for an active subscription. In some implementations, the system caches events not meeting interest criteria and periodically compares the events to interest criteria for active subscriptions to determine whether an event should be delivered to an application.

If the received event does meet interest criteria for the subscription, at a decision block 440, the system 200 determines whether delivery criteria are met for delivering the event to the subscribed application. Delivery criteria can include conditions that are to be observed by the system for an event to be delivered to a subscriber application. The system determines whether any delivery criteria apply to the event. A delivery criterion can identify events that it applies to. For example, a delivery criterion can include that it applies to all events of a particular domain. In some implementations, the system determines that a delivery criterion applies to an event when the event includes a value for a property of the event that meets a requirement of the delivery criterion. A delivery criterion may apply to all events.

When delivery criteria apply to an event, the system 200 evaluates the delivery criteria to determine whether they are met. The system evaluates delivery criteria in various ways. For instance, for delivery criteria including that an event be delivered at a particular time, the system compares a current time to the time specified by the delivery criteria. And for delivery criteria including that the system not deliver more than a predetermined quantity of events to a subscriber application over a predetermined time period, the system compares events delivered to the subscriber application over time to the predetermined event quantity and predetermined time. The system determines that delivery criteria are not met when a delivery criterion is not met. When the system determines that delivery criteria are not met, the process proceeds to a decision block 445, and the system determines whether the delivery criteria that apply to the event could be met. In some implementations, the system determines that delivery criteria for an event could be met if it is not impossible for the delivery criteria to be met. In some implementations, the system determines that delivery criteria for an event cannot be met if it is impossible for delivery criteria to be met. If the system determines that delivery criteria cannot be met, the process returns. If the system determines that delivery criteria could be met, the process returns to a decision block 440 and the system determines whether the delivery criteria are met. In some implementations, the system pauses for a time or until an event occurs before checking again whether delivery criteria are met. For example, in some implementations, the system checks periodically, such as every 15 seconds, to determine whether a delivery criterion is met. In some implementations, the system checks whether a delivery criterion is met whenever the event would otherwise be delivered to a subscriber application.

When the system determines that all delivery criteria for an event are met, the process 400 proceeds to a block 450, and the system 200 delivers the event to the subscriber application. The system can provide the event by the subscriber application binding to the system. In some implementations, the event is associated with priority information related to delivering the event, and the system delivers the event to a subscriber application at a time or in an order relative to other events that is selected based at least in part on the priority information. For example, a domain may provide for a priority property for an event, and a data node generates an event of the domain that includes that the event is associated with a lowest priority for delivery. When throttling events for delivery to a data node, the system may refrain from delivering the event until all higher priority events that are ripe for delivery are delivered to subscriber applications.

An event delivered to a subscriber application may include information that a subscriber can use for obtaining supplemental data. At a decision block 455, the system determines whether the subscriber application has requested supplemental data for an event. A request for supplemental data may identify the supplemental data according to instructions included in an event. When no supplemental data is associated with an event, the system determines that supplemental data has not been requested from the subscriber application. In some implementations, when the system has not received a request for supplemental data from a subscriber application and a predetermined time period has passed, the system determines that supplemental data has not been requested from a subscriber application. When the system determines that no supplemental data has been requested by the subscriber application, the process 400 returns. When supplemental data is associated with an event and a request for supplemental data is received from the subscriber application, the process 400 proceeds to a block 460, and the system provides the supplemental data to the subscriber application. In some implementations, the system provides cached supplemental data. In some implementations, the system obtains supplemental data requested by a subscriber application from a data node. For example, the system may request and receive supplemental data from a data node in response to a request for supplemental data from a subscriber application.

In some implementations, a delivery act is associated with delivery of an event or delivery of supplemental data to a subscriber. For example, a delivery act may include that monetary value be transferred from a subscriber application to a data node when supplemental data is provided to the subscriber application. The system can perform a delivery act after it is triggered.

### Conclusion

The disclosed system and method enable the communication to a subscriber application of information related to interesting occurrences in an application that publishes the information. The disclosed system and method enable the communication of this information without requiring a strict binding by a subscriber application when no data is flowing. The disclosed system and method enable efficient, secure, and privacy-minded sharing of useful data related to occurrences in a first application process running on a device with other application processes running on the device that are interested in the occurrences. The disclosed system and method enable a user to control whether data related to an occurrence at a data node can be shared with a subscriber application. The system generates alerts for informing a user that an event may be shared with a subscriber application, enabling the user to control whether to allow the event, or events like it, to be delivered to the subscriber application.

Those skilled in the art will appreciate that the actual implementation of a data storage area may take a variety of forms, and the phrase “data storage area” is used herein in the generic sense to refer to any area that allows data to be stored in a structured and accessible fashion using such applications or constructs as databases, tables, linked lists, arrays, and so on.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times.

In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

I/we claim:

1. A method for providing information related to an occurrence at a data node to a subscriber application interested in the information, the method performed by a processor executing instructions stored in a memory, the method comprising:
receiving, from a subscriber application running on a device, a request to be provided events that are of interest to the subscriber application, wherein an event comprises information related to an occurrence at a data node;
receiving, from the subscriber application, interest criteria for identifying events that are of interest to the subscriber application,
wherein the interest criteria include a domain for events that are of interest to the subscriber application,
wherein the interest criteria include action criteria for an action included in an event that is of interest to the subscriber application,
wherein the action is associated with an occurrence at a data node,
wherein the action criteria include that an action included in an event of interest to the subscriber application be one of one or more included predefined actions, and
wherein the one or more included predefined actions comprises an action in a semantic space of the domain;
generating a graphical user interface including an option for approving that the subscriber application be provided events meeting the received interest criteria;
when an indication is received that a user has approved, via the option included in the graphical user interface, that the subscriber application be provided events meeting the received interest criteria, subscribing the subscriber application for events meeting the received interest criteria;
receiving events from data nodes,
wherein receiving events from data nodes includes receiving a first event and a second event;
comparing the interest criteria with the first event;
determining, based at least in part on the comparison of the interest criteria and the first event, that the first event meets the interest criteria,
wherein the first event is of the domain included in the interest criteria, and
wherein the first event includes an action included in the action criteria of the interest criteria; and
determining, based on the first event meeting the interest criteria, that the first event is of interest to the subscriber application and that the user approves of providing the first event to the subscriber application;
comparing the interest criteria with the second event;
determining, based at least in part on the comparison of the interest criteria and the second event, that the second event does not meet the interest criteria;
determining, based on the second event not meeting the interest criteria, that the second event is not of interest to the subscriber application; and
providing, to the subscriber application, events that are determined to be of interest to the subscriber application and approved by the user to be provided to the subscriber application,
wherein providing events that are determined to be of interest includes providing the first event and not the second event to the subscriber application.

2. The method of claim 1, wherein the data nodes include an application, and wherein an occurrence at a data node includes an occurrence of predefined functionality of the application.

3. The method of claim 1,
wherein the interest criteria include target criteria for a target included in an event that is of interest to the subscriber application,
wherein the target is associated with a subject of the occurrence at the data node,
wherein the target criteria include that a target included in an event of interest to the subscriber application be one or more targets in a semantic space of the domain; and
wherein the first event includes a target included in the target criteria.

4. The method of claim 3,
wherein the interest criteria include attribute criteria for an attribute included in an event that is of interest to the subscriber application,
wherein an attribute in an event comprises metadata associated with a target and/or an action of an event,
wherein attribute criteria include a key, an operator, and a value,
wherein the key comprises a key from a list of keys in the semantic space of the domain that correspond to the target, action pair,
wherein the operator comprises a comparison operator, and
wherein the value includes acceptable values for the key;
wherein the attribute criteria include that a target included in an event of interest to the subscriber application be one or more targets in a semantic space of the domain; and
wherein the first event includes a target included in the target criteria.

5. The method of claim 1, wherein the subscriber application is a first subscriber application, the interest criteria are first subscriber interest criteria, the domain included in the first subscriber interest criteria is a first domain, and wherein the method further comprises:
receiving, from a second subscriber application running on a device, a request to be provided events that are determined to be of interest to the second subscriber application;
receiving, from the second subscriber application, second subscriber interest criteria for identifying events that are of interest to the second subscriber application,
wherein the second subscriber interest criteria include a second domain for events that are of interest to the second subscriber application,
wherein the second subscriber interest criteria include second action criteria for an action included in an event that is of interest to the second subscriber application, and
wherein the action is associated with an occurrence at a data node, and
wherein the second action criteria include that an action included in an event of interest to the second subscriber application be one of one or more predefined actions identified in the criteria for an action included in the second subscriber interest criteria, and
wherein the one or more predefined actions identified in the criteria for an action comprises an action in a semantic space of the second domain;
generating a graphical user interface including an option for approving that the second subscriber application be provided events meeting the received second subscriber interest criteria;
when an indication is received that the user has approved, via the option included in the graphical user interface, that the second subscriber application be provided events meeting the received second subscriber interest criteria, subscribing the second subscriber application for events meeting the received second subscriber interest criteria;
comparing the second subscriber interest criteria with the first event;
determining, based at least in part on the comparison of the second subscriber interest criteria and the first event, that the first event does not meet the second subscriber interest criteria;
determining, based on the first event not meeting the second subscriber interest criteria, that the first event is not of interest to the second subscriber application;
comparing the second subscriber interest criteria with the second event;
determining, based at least in part on the comparison between the second subscriber interest criteria and the second event, that the second event meets the second subscriber interest criteria,
wherein the second event is of the second domain included in the second subscriber interest criteria, and
wherein the second event includes an action included in the second action criteria of the second subscriber interest criteria; and
determining, based on the second event meeting the second subscriber interest criteria, that the second event is of interest to the second subscriber application and that the user approves of providing the second event to the second subscriber application; and
providing, to the second subscriber application, events that are determined to be of interest to the second subscriber application and approved by the user to be provided to the second subscriber application,
wherein providing events that are determined to be of interest to the second subscriber application includes providing the second event and not the first event to the subscriber application.

6. The method of claim 5, wherein the method further comprises:
identifying delivery criteria that apply to providing the first event to the first subscriber application;
identifying delivery criteria that apply to providing the second event to the second subscriber application,
wherein the delivery criteria that apply to providing the first event to the first subscriber application are different from the delivery criteria that apply to providing the second event to the second subscriber application;
evaluating whether the delivery criteria that apply to providing the first event to the first subscriber application are met;
determining, based on the evaluation of whether the delivery criteria for providing the first event are met, that the delivery criteria that apply to providing the first event to the first subscriber application are met;
evaluating whether the delivery criteria that apply to providing the second event to the second subscriber application are met; and
determining, based on the evaluation of whether the delivery criteria for providing the second event are met, that the delivery criteria for providing the second event to the second subscriber application are met,
wherein providing, to the first subscriber application, events that are determined to be of interest to the first subscriber application and approved by the user to be provided to the first subscriber application includes: providing to the first subscriber an event determined to be of interest to the first subscriber when delivery criteria that apply to providing the event to the first subscriber application are met, and
wherein providing, to the second subscriber application, events that are determined to be of interest to the second subscriber application and approved by the user to be provided to the second subscriber application includes: providing to the second subscriber application an event determined to be of interest to the second subscriber application when delivery criteria that apply to providing the second event to the second subscriber application are met.

7. The method of claim 5, wherein the delivery criteria that apply to providing the first event to the first subscriber application include that the subscriber application be authenticated.

8. The method of claim 1, wherein subscribing the subscriber application for events meeting the received interest criteria includes subscribing the subscriber application for events meeting the received interest criteria if a subscription requirement is met.

9. A system for providing information related to an occurrence at a data node to a subscriber application interested in the information, the system comprising:
a memory storing computer-executable instructions of:
a subscriber communication module configured to:
receive, from a subscriber application, a request to be provided events that are determined to be of interest to the subscriber application,
wherein an event includes an action included in a semantic space of a domain that the event belongs to, and
wherein the action is associated with an occurrence at the data node;
receive, from the subscriber application, interest criteria for events that the subscriber application is interested in being provided,
wherein the interest criteria include the domain for events that the subscriber application is interested in being provided;
provide, to the subscriber application, an event received from the event delivery control module, determined to be of interest to the subscriber application,
wherein the event is of the domain included in the interest criteria received form the subscriber application;
a data nodes communication module configured to:
receive a first event from a data node; and
receive a second event from the data node;
an interesting event identification module configured to:
compare the interest criteria received from the subscriber application with each of the first event and the second event;
determine, based on the comparison between the interest criteria and the first event, that the first event meets the interest criteria;
record, based on the first event meeting the interest criteria, that the first event is of interest to the subscriber application;
determine, based on the comparison between the interest criteria and the second event, that the second event does not meet the interest criteria;
determine, based on the second event not meeting the interest criteria, that the second event is not of interest to the subscriber application; and
an event delivery control module configured to:
identify delivery criteria that apply to a delivery of the first event to the subscriber application;
evaluate the delivery criteria that apply to the delivery of the first event to the subscriber application;
determine, based on the evaluation of the delivery criteria, that the delivery criteria are met; and
provide the first event to the subscriber communication module for delivery to the subscriber application; and
a processor for executing the computer-executable instructions stored in the memory.

10. The system of claim 9, further comprising a user interface module configured to: generate a graphical user interface including an option for approving that the subscriber application be provided events meeting the interest criteria; and receive an indication from a user, via the option included in the graphical user interface, that the subscriber application be provided events meeting the interest criteria.

11. The system of claim 9, wherein:
the subscriber communication module is further configured to:
deliver a third event to the subscriber application when provided the third event from the event delivery control module;
the data nodes communication module is further configured to:
receive a third event from a data node;
the interesting event identification module is further configured to:
compare the interest criteria received from the subscriber application with the third event;
determine, based on the comparison between the interest criteria and the third event, that the third event meets the interest criteria;
record, based on the third event meeting the interest criteria, that the third event is of interest to the subscriber application; and
the event delivery control module is further configured to:
identify delivery criteria that apply to delivering the third event to the subscriber application, wherein the delivery criteria that apply to delivering the third event to the subscriber application are different from the deliver criteria that apply to delivering the first event to the subscriber application;
evaluate the delivery criteria that apply to delivering the third event to subscriber application;
determine, based on the evaluation of the delivery criteria, that the delivery criteria that apply to the third event are met; and
provide the third event to the subscriber communication module for delivery to the subscriber application.

12. A non-transitory computer-readable storage medium containing instructions for performing a method for providing information related to an occurrence at a data node to a subscriber application interested in the information, the method comprising:
receiving, from a subscriber application running on a device, a request to be provided events that are of interest to the subscriber application,
wherein an event comprises information related to an occurrence at a data node;
receiving, from the subscriber application, interest criteria for identifying events that are of interest to the subscriber application,
wherein the interest criteria include a domain for events that are of interest to the subscriber application,
wherein the interest criteria include action criteria for an action included in an event that is of interest to the subscriber application,
wherein the action is associated with an occurrence at a data node,
wherein the action criteria include that an action included in an event of interest to the subscriber application be one of one or more included predefined actions, and
wherein the one or more included predefined actions comprises an action in a semantic space of the domain;
generating a graphical user interface including an option for approving that the subscriber application be provided events meeting the received interest criteria;
when an indication is received that a user has approved, via the option included in the graphical user interface, that the subscriber application be provided events meeting the received interest criteria, subscribing the subscriber application for events meeting the received interest criteria;
receiving events from data nodes,
wherein receiving events from data nodes includes receiving a first event and a second event;
comparing the interest criteria with the first event;
determining, based at least in part on the comparison of the interest criteria and the first event, that the first event meets the interest criteria,
wherein the first event is of the domain included in the interest criteria, and
wherein the first event includes an action included in the action criteria of the interest criteria; and
determining, based on the first event meeting the interest criteria, that the first event is of interest to the subscriber application and that the user approves of providing the first event to the subscriber application;
comparing the interest criteria with the second event;
determining, based at least in part on the comparison of the interest criteria and the second event, that the second event does not meet the interest criteria;
determining, based on the second event not meeting the interest criteria, that the second event is not of interest to the subscriber application; and
providing, to the subscriber application, events that are determined to be of interest to the subscriber application and approved by the user to be provided to the subscriber application,
wherein providing events that are determined to be of interest includes providing the first event and not the second event to the subscriber application.

13. The non-transitory computer readable storage medium of claim 12, wherein the data nodes include an application, and wherein an occurrence at a data node includes an occurrence of predefined functionality of the application.

14. The non-transitory computer readable storage medium of claim 12,
wherein the interest criteria include target criteria for a target included in an event that is of interest to the subscriber application,
wherein the target is associated with a subject of the occurrence at the data node,
wherein the target criteria include that a target included in an event of interest to the subscriber application be one or more targets in a semantic space of the domain; and
wherein the first event includes a target included in the target criteria.

15. The non-transitory computer readable storage medium of claim 14,
wherein the interest criteria include attribute criteria for an attribute included in an event that is of interest to the subscriber application,
wherein an attribute in an event comprises metadata associated with a target and/or an action of an event,
wherein attribute criteria include a key, an operator, and a value,
wherein the key comprises a key from a list of keys in the semantic space of the domain that correspond to the target, action pair,
wherein the operator comprises a comparison operator, and
wherein the value includes acceptable values for the key;
wherein the attribute criteria include that a target included in an event of interest to the subscriber application be one or more targets in a semantic space of the domain; and
wherein the first event includes a target included in the target criteria.

16. The non-transitory computer readable storage medium of claim 12, wherein the subscriber application is a first subscriber application, the interest criteria are first subscriber interest criteria, the domain included in the first subscriber interest criteria is a first domain, and wherein the method further comprises:
receiving, from a second subscriber application running on a device, a request to be provided events that are determined to be of interest to the second subscriber application;
receiving, from the second subscriber application, second subscriber interest criteria for identifying events that are of interest to the second subscriber application,
wherein the second subscriber interest criteria include a second domain for events that are of interest to the second subscriber application,
wherein the second subscriber interest criteria include second action criteria for an action included in an event that is of interest to the second subscriber application, and
wherein the action is associated with an occurrence at a data node, and
wherein the second action criteria include that an action included in an event of interest to the second subscriber application be one of one or more predefined actions identified in the criteria for an action included in the second subscriber interest criteria, and
wherein the one or more predefined actions identified in the criteria for an action comprises an action in a semantic space of the second domain;
generating a graphical user interface including an option for approving that the second subscriber application be provided events meeting the received second subscriber interest criteria;
when an indication is received that the user has approved, via the option included in the graphical user interface, that the second subscriber application be provided events meeting the received second subscriber interest criteria, subscribing the second subscriber application for events meeting the received second subscriber interest criteria;
comparing the second subscriber interest criteria with the first event;
determining, based at least in part on the comparison of the second subscriber interest criteria and the first event, that the first event does not meet the second subscriber interest criteria;
determining, based on the first event not meeting the second subscriber interest criteria, that the first event is not of interest to the second subscriber application;
comparing the second subscriber interest criteria with the second event;
determining, based at least in part on the comparison between the second subscriber interest criteria and the second event, that the second event meets the second subscriber interest criteria,
wherein the second event is of the second domain included in the second subscriber interest criteria, and
wherein the second event includes an action included in the second action criteria of the second subscriber interest criteria; and
determining, based on the second event meeting the second subscriber interest criteria, that the second event is of interest to the second subscriber application and that the user approves of providing the second event to the second subscriber application; and
providing, to the second subscriber application, events that are determined to be of interest to the second subscriber application and approved by the user to be provided to the second subscriber application,
wherein providing events that are determined to be of interest to the second subscriber application includes providing the second event and not the first event to the subscriber application.

17. The non-transitory computer readable storage medium of claim 16, wherein the method further comprises:
identifying delivery criteria that apply to providing the first event to the first subscriber application;
identifying delivery criteria that apply to providing the second event to the second subscriber application,
wherein the delivery criteria that apply to providing the first event to the first subscriber application are different from the delivery criteria that apply to providing the second event to the second subscriber application;
evaluating whether the delivery criteria that apply to providing the first event to the first subscriber application are met;
determining, based on the evaluation of whether the delivery criteria for providing the first event are met, that the delivery criteria that apply to providing the first event to the first subscriber application are met;
evaluating whether the delivery criteria that apply to providing the second event to the second subscriber application are met; and
determining, based on the evaluation of whether the delivery criteria for providing the second event are met, that the delivery criteria for providing the second event to the second subscriber application are met,
wherein providing, to the first subscriber application, events that are determined to be of interest to the first subscriber application and approved by the user to be provided to the first subscriber application includes: providing to the first subscriber an event determined to be of interest to the first subscriber when delivery criteria that apply to providing the event to the first subscriber application are met, and
wherein providing, to the second subscriber application, events that are determined to be of interest to the second subscriber application and approved by the user to be provided to the second subscriber application includes: providing to the second subscriber application an event determined to be of interest to the second subscriber application when delivery criteria that apply to providing the second event to the second subscriber application are met.

18. The non-transitory computer readable storage medium of claim 16, wherein the delivery criteria that apply to providing the first event to the first subscriber application include that the subscriber application be authenticated.

19. The non-transitory computer readable storage medium of claim 12, wherein subscribing the subscriber application for events meeting the received interest criteria includes subscribing the subscriber application for events meeting the received interest criteria if a subscription requirement is met.

20. The non-transitory computer readable storage medium of claim 12, wherein generating a graphical user interface including an option for approving that the subscriber application be provided events meeting the received interest criteria comprises generating an alert at a mobile device of the user, wherein the alert comprises the graphical user interface.
